(19) United States
(12) Patent Application Publication
(10) Pub. No.: US 2004/0182333 A1
(43) Pub. Date: Sep. 23, 2004

(54) Embraced moving cylinder and methods of using same

(76) Inventor: Charles Maling, Boone, NC (US)

Correspondence Address: ADAM EVANS, P.A., (formerly Adams, Schwartz & Evans, P.A.), 2180 TWO WACHOVIA CENTER, CHARLOTTE, NC, 28282, US

(21) Appl. No.: 10/804,962

(22) Filed: Mar. 19, 2004

Related U.S. Application Data
(60) Provisional application No. 60/456,125, filed on Mar. 20, 2003.

(51) Int. Cl. F02B 33/10; F02B 59/00

(52) U.S. Cl. 123/42

(57) ABSTRACT

A moving cylinder assembly includes a cylinder having a chamber for receiving and engaging a piston, and a housing immediately embracing the cylinder and defining a slot through which the piston is positioned to allow for oscillating movement of the piston within the slot. The cylinder engages in reciprocal oscillating movement with the piston. The immediate embracement of the cylinder by the housing minimizes leakage between the cylinder and the housing. The cylinder assembly is suitable for use in an engine, compressor, pump or vacuum pump.

### TECHNICAL FIELD AND BACKGROUND OF THE INVENTION

This application claims the benefit of U.S. Provisional Application No. 60/456, 125, filed Mar. 20, 2003. This invention relates to a moving cylinder for providing an efficient piston drive mechanism of the utmost simplicity. A partial list of applications of the invention includes use in external and internal combustion engines, pumps, compressors and vacuum pumps. The invention comprises a moving cylinder sufficiently embraced or surrounded by a generally fixed housing so as to prevent blow-by or leakage, and in some embodiments to provide a bearing. The embracement can be virtually complete and includes both ends. The most useful embodiments comprise oscillating cylinders embraced by housings rounded on the inside comprising, or within, pressure controlled containers. The pressure control could be passively accomplished by simply sealing or it could be active. The embodiments of the presented invention have types of end porting which allows for large ports and eliminates the need for dead space at the end of piston travel. The embodiments also generally minimize the mass and the rotational momentum of the oscillating cylinders.

One long-standing way to control the flows in a steam engine is with an oscillating cylinder. Oscillating cylinders have existed almost since the beginning of piston driven steam engines. Their use historically has mostly been in marine steam engines. Some limited use was also found in steam locomotives. The advantage of oscillating cylinders was in its mechanical simplicity and its direct transfer of power from piston to driving wheel, or crankshaft, or vice versa. The disadvantage was that existing designs did not succeed in maintaining the high pressures required for efficient operation. This disadvantage has so outweighed the advantages that current use of oscillating cylinders is primarily limited to toy steam engines and locomotives where little or no useful work is being powered.

The most relevant patent background of the core mechanism exists as steam engines using oscillating cylinders. Various methods were offered to control the leaks which plagued such engines and limited the attainable pressures. Most used screws or springs or a combination of the two at the center pivot point to hold together the sliding surfaces which control the flows. The force holding the surfaces together had to be just right. Too great and the surfaces could not move relative to each other seizing the engine. Too little and the interface would leak. The higher the pressure sought, the more elusive the goal of finding the just right force.

U.S. Pat. No. 12,052 to Cridge et al., U.S. Pat. No. 30,240 to Otis, U.S. Pat. No. 448,917 to Garland, and U.S. Pat. No. 815,632 to Pilling all disclosed the use of screws to apply the force. U.S. Pat. No. 125,773 to Van Sant and U.S. Pat. No. 2,603, 193 to Flory use springs. U.S. Pat. No. 2,326,494 to Ratzburg discloses using a spring with a screw tensioner. U.S. Pat. No. 3,720, 139 to Blackney used roller bearings with screw adjustments. These mechanisms were often incidental to other objectives of these patents, such as providing a reversing or speed control mechanism.

A few patents disclosed the use of pressure itself to offset the working of pressure to separate the surfaces which controlled the flows. U.S. Pat. No. 242,851 to Abbott et al. disclosed such a mechanism in a patent whose principal objective was to provide a reversing gear. U.S. Pat. No. 26,853 to Mackintosh et al. and U.S. Pat. No. 4,114,514 to Lettines offered this in patents whose principal intent was to solve the problem of leakage. All these efforts suffered from an clear failing; the pressure to resist the separation of the flow controlling surfaces was applied at the pivot point of the oscillating cylinders while the pressure working to separate the surfaces was distant from the pivot. The greater leverage of the latter over the former guaranteed failure.

There are known internal combustion engine designs using oscillating cylinders. These generally use trunnions to hold the cylinder(s) tight against some surface containing ports. Most designs also make use of additional valves of some sort. The designs lack the mechanical simplicity which makes use of oscillating cylinders in steam engines appealing. The actual operation of engines based on some of the early designs is doubtful. None of these designs offer any real advantage over the existing art.

A few internal combustion engine patents are relevant to the internal combustion engine embodiments of this invention. U.S. Pat. No. 878,578 to Thompson is most similar in that it used a pair of oscillating cylinders to control all the flows for a four stroke engine. The cylinders disclosed by Thompson “578 are very complex and the passages between them are long. Except in extremely large scale versions, useful compression ratios would not be obtainable without making passages which must sustain combustion too narrow to do so. Thompson “578 may have been misled by the mistaken notion that adjacent cylinders must be 180 degrees out of phase to have a balanced crankshaft. The four stroke embodiments of this application's invention uses cylinder pairs basically in phase to keep the in-between passages short.

U.S. Pat. Nos. 5,275, 134 and 5,526,778 to Springer also disclosed using multiple oscillating cylinders to control all the flows. In its simplest version, two cylinders are used in an engine producing power in two strokes in only one of the cylinders. The engine has all the mechanical complexity and the relation of power to size and weight of a conventional four stroke with no apparent gain in efficiency or reduced emissions.

The trunnion head disclosed in U.S. Pat. Nos. 1,135,365 and 1,374,140 to Dock shares a feature with the invention of the present application. The embracement of that trunnion is used to limit leakage much as the embracement of the oscillating cylinder of this application is used to limit leakage. However, the embracement is made more complicated and less effective by sleeve valves between the trunnion head and the surrounding fixed housing. Additionally, the embracement of Dock is only at one end of a rather complex cylinder, which even includes a water jacket. The oscillating cylinder embodiments offered with this application use a sealed fixed housing immediately embracing the cylinder at both ends to limit leakage. The embracement is generally as complete as feasible.

A somewhat similar embracement of a trunnion head, again at one end, appears in the drawing figures of Japanese Patent No. 10-220239 to Futoshi. The oscillating cylinder of that patent rivals that of Dock's in its complexity. Also, neither it nor Dock's cylinder are suitable for two-sided use, which is a major drawback.

### SUMMARY OF THE INVENTION

Therefore it is an object of the present invention to provide an efficient and simple piston drive mechanism.

Another object of the present invention is to provide a moving cylinder for use in a combustion engine that maintains sufficient pressures for efficient operation.

These and other objects of the present invention are achieved in the preferred embodiments disclosed below by positioning a moving cylinder in a housing which embraces both ends within or comprising a sealed container so as to prevent blow-by.

According to one preferred embodiment of the invention, the housing has a cylindrical interior. Matched to the cylindrical housing is a cylinder with a cylindrical exterior.

According to another preferred embodiment of the invention, the housing has a spherical interior. Matched to the spherical housing is a ball shaped cylinder.

According to yet another preferred embodiment of the invention, the cylinder is adapted for linear sliding movement.

The invention comprises all the specific, or essentially similar, profiles of cylinders and porting arrangements described herein. The invention comprises one sided versions as well as two-sided, housings flattened or reduced where there is no contact with the oscillating cylinder embraced, and side ported arrangements where blow-by is controlled by the immediate embracement of a housing. The invention also comprises shapes which combine elements from various embodiments offered herein. The invention also comprises the use of cone shaped sides, trunnions or other additions for the purpose of providing various bearings. Similarly, the invention comprises the use of holes or subtractions for the purpose of inserting bearings. Subtractions for the purpose of reducing mass of the oscillating cylinder and/or bringing coolant closer to the cylinder barrel are also possible. Cylinder barrels and pistons other than round could be used in this invention, though round would generally be preferred for ease of manufacture. Directions of rotation, positioning of cylinder pairs and such are only illustrative. There is no attempt here to itemize all the potential variations on the embodiments presented nor all the uses to which they can be put.

According to the preferred embodiments of the invention, cylinder arrangements with end porting, when relevant, are embraced within a sealed housing as a remedy of the low pressure drawback. In addition, in some applications the mechanics can be simplified by eliminating the need for a separate bearing. Also, where a working chamber is maintained on only one side of the piston, the shape of the parts involved can be particularly simple. That, the small number of parts, and the absence of any unusually small parts, would enable the device's use in miniature applications.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic view of the operation of a prior art two sided oscillating cylinder with a crankshaft;

FIG. 2 is a schematic view of an oscillating cylinder assembly according to a preferred embodiment of the invention in operation with a crankshaft;

FIG. 3A is a right side elevation of the cylinder of FIG. 2, showing the piston rod hole and alignment band;

FIG. 3B is a right side elevation of an alternative embodiment of the cylinder of FIG. 2;

FIG. 3C is a view of the piston rod positioned within a slot in the housing;

FIG. 3D is a perspective view of a preferred embodiment of the cylinder of FIG. 2;

FIG. 3E is a side elevation of a piston according to a preferred embodiment of the invention, for use with the cylinder of FIG. 3A;

FIG. 3F is a side elevation of an alternative embodiment of a piston according to the invention, for use with the cylinder of FIG. 3B;

FIG. 3G is a side elevation of another alternative embodiment of a piston according to the invention, for use with the cylinder of FIG. 3D;

FIG. 3H is a bottom plan view of the piston of FIG. 3E, as viewed from the crankshaft;

FIG. 3I is a bottom plan view of the piston of FIG. 3F, as viewed from the crankshaft;

FIG. 3J is a bottom plan view of the piston of FIG. 3G, as viewed from the crankshaft;

FIGS. 4A-D are schematic views illustrating the operation of the cylinder assembly of FIG. 2;

FIGS. 5A-B show the ports on opposite sides of the cylinder housing of FIG. 2 in relation to the cylinder barrel when positioned between intake and exhaust;

FIG. 6A is an exploded perspective view of the oscillating cylinder assembly of FIG. 2;

FIG. 6B is a top plan cross sectional view of the housing of the cylinder assembly of FIG. 6A;

FIG. 6C is a top plan cross sectional view of an alternative embodiment of the housing of the cylinder assembly of FIG. 6A;

FIG. 7A is a perspective view of the oscillating cylinder of FIG. 3A;

FIG. 7B is a perspective view of the oscillating cylinder of FIG. 3B;

FIG. 8A is a side view of a cylinder according to another preferred embodiment of the invention;

FIG. 8B is a view of the cylinder of FIG. 8A as seen from the crankshaft;

FIG. 9A is a side view of a cylinder according to yet another preferred embodiment of the invention;

FIG. 9B is a view of the cylinder of FIG. 9A as seen from the crankshaft;

FIG. 10 is a schematic view of a cylinder assembly having lubrication ports according to another preferred embodiment of the invention;

FIG. 11 shows an oscillating cylinder assembly according to yet another preferred embodiment of the invention;

FIG. 12 shows an oscillating cylinder assembly according to yet another preferred embodiment of the invention;

FIG. 13 is a schematic view of a sliding cylinder assembly according to a preferred embodiment of the invention;

FIG. 14A is a perspective view of an oscillating cylinder assembly according to a preferred embodiment of the invention;

FIG. 14B is another perspective view of the cylinder assembly of FIG. 14A;

FIG. 15A is a perspective view of the cylinder of the cylinder assembly of FIG. 14A;

FIG. 15B is a perspective view of the piston of the cylinder assembly of FIG. 14A;

FIG. 15C is a top plan view of the piston and cylinder of the cylinder assembly of FIG. 14A;

FIG. 15D is a top plan view of the piston of the piston of FIG. 15C;

FIG. 15E is a side elevation of the piston and cylinder of the cylinder assembly of FIG. 14A;

FIG. 15F is a side elevation of the piston of FIG. 15E;

FIG. 16A is a perspective view of a cylinder according to another preferred embodiment of the invention;

FIG. 16B is a perspective view of a piston for use with the cylinder of FIG. 16A;

FIGS. 17A-D are schematic views showing a cylinder assemby in operation in a combustion engine according to a preferred embodiment of the invention;

FIGS. 18A-D are schematic views showing a pair of cylinder assemblies in operation in a combustion engine according to another preferred embodiment of the invention;

FIG. 19A is a top plan view of the pair of cylinders of FIGS. 18A-D, showing the shape of the ignition chamber;

FIG. 19B is a perspective view of the cylinder pair of FIGS. 18A-D showing the shape of the ignition chamber;

FIGS. 20A-D are schematic views showing a pair of cylinder assemblies in operation in a combustion engine according to yet another preferred embodiment of the invention;

FIG. 21A is a perspective view of the passages and ignition chambers for the cylinder pair of FIGS. 20A-D;

FIG. 21 B is another perspective view of the passages and ignition chambers for the cylinder pair of FIGS. 20A-D, as seen from the side opposite the crankshaft;

FIG. 21 C is yet another perspective view of the passages and ignition chambers for the cylinder pair of FIGS. 20A-D, as seen from the crankshaft;

FIG. 22A is a side view of a one piece cylinder pair according to another preferred embodiment of the invention;

FIG. 22B is a bottom view of the one piece cylinder pair of FIG. 22A;

FIG. 23A is a side view of a one piece cylinder pair according to yet another preferred embodiment of the invention;

FIG. 23B is a bottom view of the one piece cylinder pair of FIG. 23A;

FIGS. 24A-D are schematic views of a pair of cylinder assemblies according to another preferred embodiment of the invention, shown in operation;

FIG. 25 is a partial perspective view of the pair of cylinder assemblies of FIGS. 24A-D;

FIG. 26 is a schematic view of a pair of cylinders according to another preferred embodiment of the invention;

FIG. 27 is another schematic view of the cylinders of FIG. 26;

FIG. 28 is a schematic view of a pair of cylinders according to another preferred embodiment of the invention; and

FIG. 29 is an enlarged view of an ignition chamber and compression-varying piston according to a preferred embodiment of the invention.

### DETAILED DESCRIPTION OF THE PREFERRED EMBODIMENTS AND BEST MODE

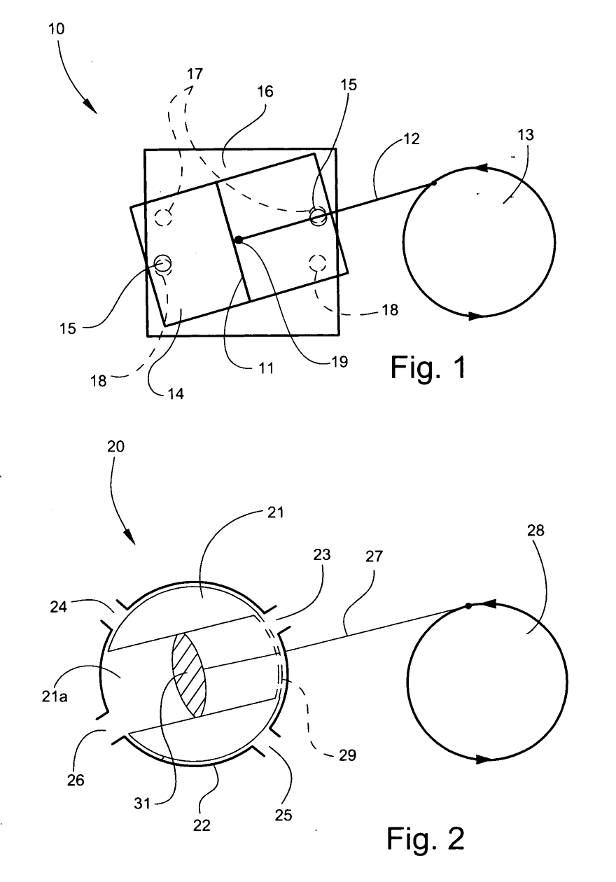

A prior art two sided oscillating cylinder assembly is illustrated in FIG. 1, and shown generally at reference numeral 10. The cylinder assembly 10 includes a piston head 11 and a rod 12 attached directly to a drive wheel or crankshaft 13. A cylinder 14 is generally held in place by some sort of bearing at a center pivot point 19 which allows the cylinder 14 to rock or oscillate with the movement of the piston head 11. Holes 15 at both ends of the cylinder 14 slide against a surface 16 containing entrance and exit ports 17, 18, respectively, located such as to be open to the cylinder holes 15 at the appropriate points in the movement of the piston 11. The cylinder 14 will also have a flat surface in the same plane as the holes 15 so as to seal the ports 17, 18 when not in use. This flat surface of the cylinder and the ported surface 16 together make up a flow distributing interface. The difficulty with this arrangement is that high pressures tend to blow the cylinder 14 away from the surface 16 containing the entrance and exit ports 17, 18, thus limiting the pressure, and generally throwing off oil in the process. An alternative arrangement which has been used is to have the porting through trunnions holding the cylinder 14 in place. This arrangement has been only marginally more successful in maintaining high pressures and is more difficult to build. Means to hold the mated surfaces containing the ports together to prevent leakage involved screws, springs or pressure itself usually with force applied at the pivot point of oscillation.

The failure of these arrangements appears to stem from two major drawbacks. One is the large area from which leaks to the outside can occur. From the points where high pressure is introduced to the flow directing interface, the entrance ports 17, leaks to the outside can generally radiate in virtually all directions (360 degrees). Second, what holds the surfaces of the interface together is generally a bearing or bearings at the pivot point of oscillation. With side porting arrangements such as illustrated in FIG. 1, high pressure is introduced at points distant from that pivot point. The leverage thus created makes it hard for the bearing(s) to resist the separation of the surfaces. Porting through trunnions along the axis of oscillation would eliminate that leverage but at the cost of a more complicated and massive cylinder. Alternatively, sufficiently long trunnions could be provided a countervailing leverage but would add space and mass requirements to the assembly.

As shown below, the invention of this application, by having the cylinder embraced or surrounded as completely as possible by a housing, limits the potential leakage to the outside to a small area. Furthermore, the embracement itself prevents the cylinder from being blown away from the housing. Since the flow controlling interface is that between the cylinder and the embracing housing, it is impossible for the surfaces of that interface to separate. Finally, by using end porting, high pressure ports along the flow directing interface have no leverage over any bearings at the pivot axis of oscillation.

A cylinder assembly according to a preferred embodiment of the invention is illustrated in FIG. 2, and shown generally at reference numeral 20. The cylinder assembly 20 comprises an open end cylinder 21 inside a housing 22, which also serves as a sealed container. The term “cylinder” as used throughout this application refers generally to a solid object having a chamber in which a piston moves, and is not intended to be limited to any particular shape. Particular preferred shapes of the cylinder 21 are discussed in detail below.

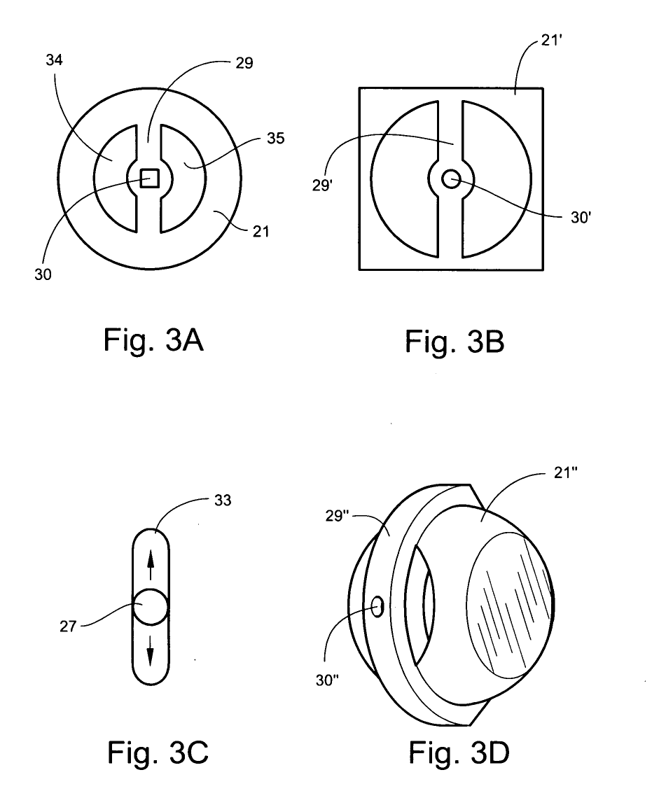

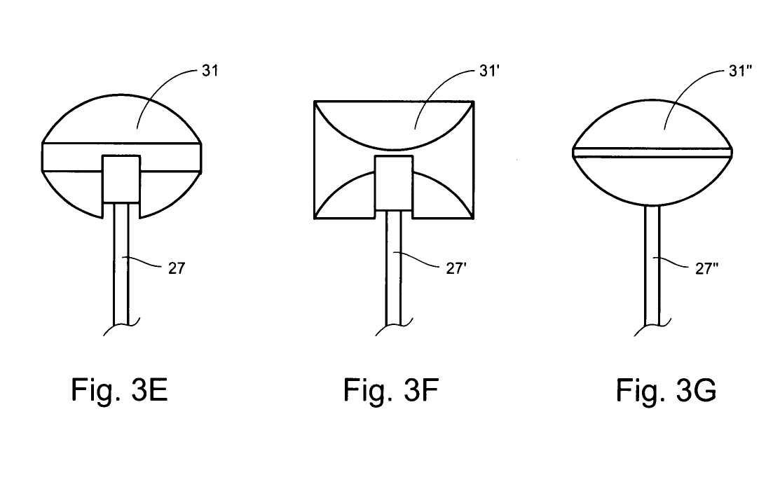

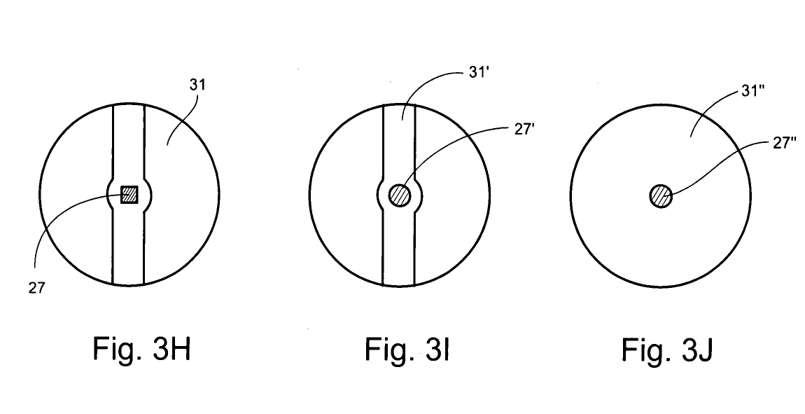

The housing 22 preferably defines two entrance ports 23, 24 and two exit ports 25, 26, and a slot 33 through which a piston rod 27 connected to a crank 28 is inserted that allows for oscillating movement of the piston rod 27. The oscillating cylinder 21 is open on the ends except for an alignment band 29, shown in phantom in FIG. 2, at one end, and defines a cylindrical chamber 21a in which the piston rod 27 and piston head 31 move. As shown in FIG. 3A, the cylinder 21 can be spherical, with the alignment band 29 defining a square hole 30 through which the piston rod 27 is inserted. The alignment band 29 is shown enlarged around the hole 30 for strength. FIG. 3B shows an alternative embodiment of the cylinder 21′ having a cylindrical shape and an alignment band 29′ with a circular hole 30′.

The alignment band 29 maintains alignment between the piston rod 27 and the oscillating cylinder 21, and covers the slot 33 in the housing 22 through which the piston rod 27 must move, as shown in FIG. 3C. The square piston rod hole 30 of FIG. 3A when mated with a square piston rod is one means of preventing the rotation of the cylinder 21 such that the alignment band 29 no longer seals the slot in the housing 22. The cylindrical shaped cylinder 21′ of FIG. 3B is prevented from rotating by the housing that embraces it.

FIG. 3D shows an alternative cylinder 21″, which combines the simple shapes of FIGS. 3A and 3B along with placing the alignment band 29″ external to the spherical profile. In that case, the alignment band 29″ would be mated to a receiving groove in the housing within which it would slide.

In order to eliminate dead space at the end of the piston throw on the crank side, the piston head 31 would have to be shaped to straddle the alignment band 29 on that side. No such straddling would be required for the externally placed alignment band 29″ of FIG. 3D. FIGS. 3E, 3F, and 3G show side profiles of dead space eliminating piston heads 31, 31′, 31″ for respective use in cylinders 21, 21′, 21″ according to FIGS. 3A, 3B, 3D. The match profiles of cylinder 21″ of FIG. 3D and piston head 31″ of FIG. 3G would be most generally preferred in most smaller scale applications for simplicity of shape and low mass of oscillating and reciprocating parts. FIGS. 3H-J show bottom plan views of the piston heads 31, 31′, 31″, respectively.

An additional advantage of having an external alignment band 29″ is that the two points of contact between the one piece piston and rod 31″, 27″ and the cylinder 21″ the sides of the piston head 31″ and the hole 30″ in the alignment band 29″, are more distant from each other. This gives the piston head 31″ and rod 27″ greater leverage in imparting rotational movement to the cylinder 21″.

The required thickness of the alignment band 29 depends on the applications and the materials used. Where the momentum of the oscillating cylinder 21 must be reversed at high speeds, the band 29 would need to be stouter. Alternatively, a second alignment band could be positioned at the opposite end of the cylinder 21, with the piston rod 27 extending past the piston head 31 on the non-crankshaft side. In arctic applications, this may be preferred as a starting aid, where lubricants become highly viscous at low temperatures.

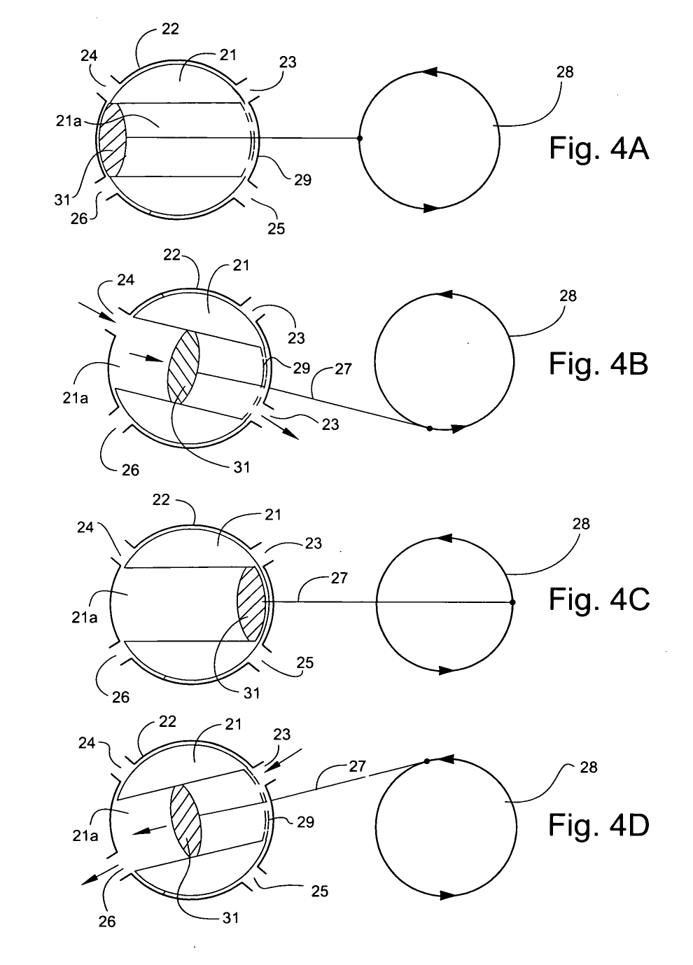

FIGS. 4A-4D illustrate the operation of the two sided cylinder assembly 20. FIG. 4A shows the cylinder assembly 20 with the piston head 31 located at the furthest extent of the piston throw and all ports 23-26 are closed off by the cylinder 21. As the crank 28 rotates and the piston head 31 moves, the cylinder 21 moves to open the entrance port 24 and the exit port 25, as shown in FIG. 4B. As the crank 28 continues to rotate, the cylinder 21 reverses direction and the piston head 31 reaches the closest point to the crank center as shown in FIGS. 4C, and all ports 23-26 are again closed. Continued movement of the crank 28 causes the piston head 31 to reverse direction and the cylinder 21 to continue moving so as to open the entrance port 23 on the piston rod side and the exit port 26 on the opposite side. From the position shown in FIG. 4D continued rotation of the crank will cause the cylinder to again reverse direction.

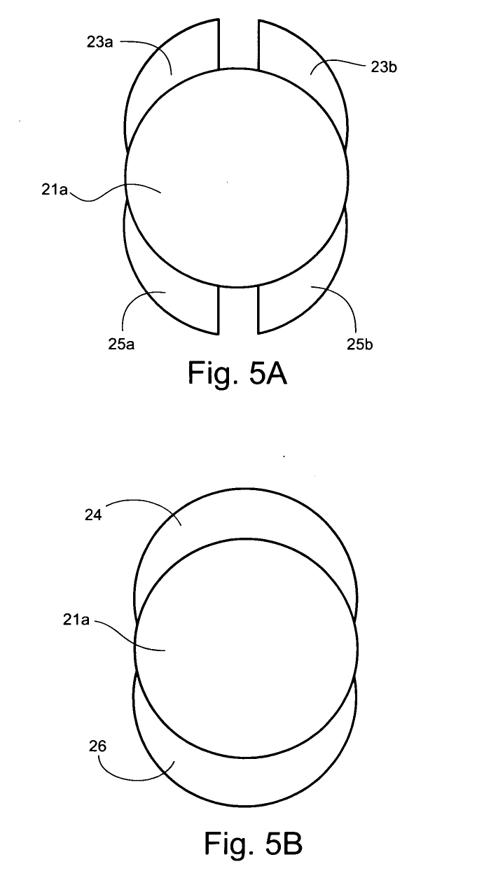

The oscillating cylinder 21 must include a surface to cover the ports 23-26 when not in use. That surface is inherent in the round cylinder 21 shown in FIG. 2. The most open shape of the ports 23-26 in the housing 22 would be crescent shaped. FIG. 5A illustrates such shapes for the ports 23, 25 on the piston rod side and FIG. 5B shows the ports 24, 26 on the opposite of the piston relative to the position of the cylinder chamber 21a at the furthest and nearest extend of the piston from the center of the crank 28. The piston rod side ports 23, 25 are each divided in to left and right segments 23a, 23b, 25a, 25b, respectively. The segmented ports 23a, 23b, 25a, 25b prevent the alignment band 29 from being subject to intake and exhaust flows. Unified ports subjecting the band 29 to flows could also be used. If an exterior alignment band, such as the alignment band 29″ shown in FIG. 3D, were used with unified ports, a more convex exterior profile of the band might be chosen to help smooth parting of the flow medium on entrance, or smooth reuniting of the flow medium on exit. Parabolic, triangular, or other smoothing external profiles of the band 29″, could also be chosen.

As shown in FIG. 3A, the cylinder 21 and alignment band 29 together define two apertures 34, 35 for intermittently aligning with the entrance port segments 23a, 23b and exit port segments 25a, 25b on the crankshaft side to control gaseous flows in and out of the cylinder chamber 21a. The opposite side of the cylinder 21 is open ended for intermittent alignment with entrance port 24 and exit port 26 to control gaseous flows in the cylinder chamber 21a on the other side of the piston head 31.

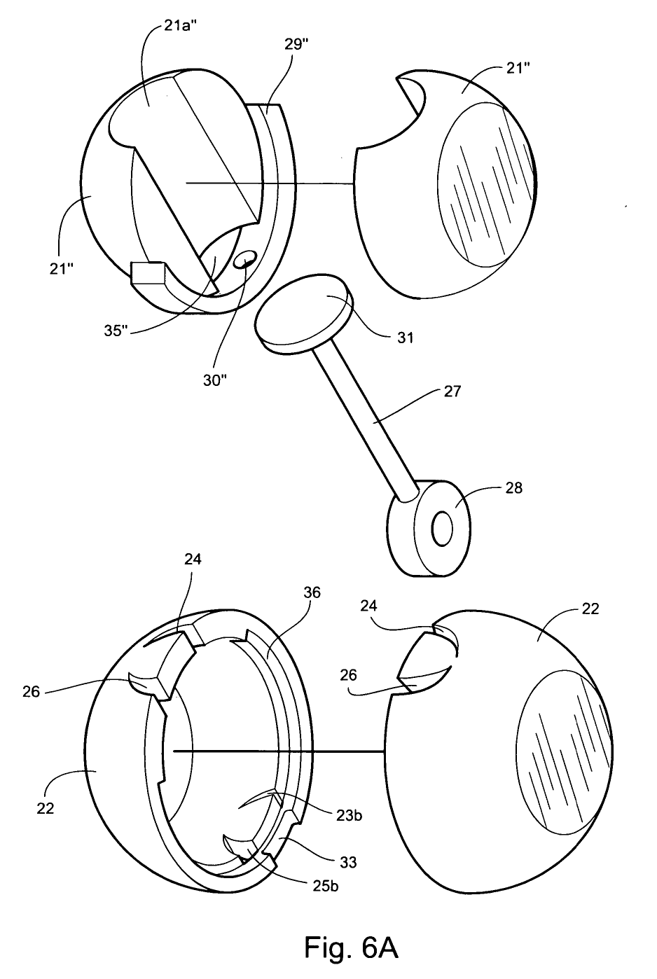

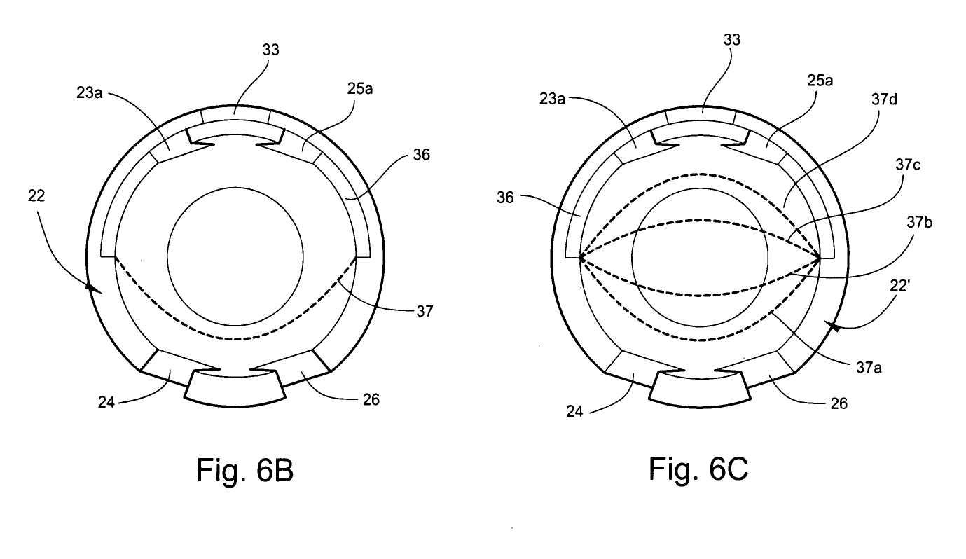

FIG. 6A shows a preferred embodiment of the cylinder assembly 20 comprising the cylinder 21″ of FIG. 3D. The inner surface of the housing 22 has an integrally formed groove 36 for receiving the alignment band 29″ extending outward from the cylinder 21″. As shown in FIG. 6B, the inner surface of the housing 22 also has a channel 37 extending from one end of the groove 36 to the other. The channel 37 helps to maintain even distribution of air or lubricant in the assembly by allowing the air or lubricant to flow from one end of the groove 36 to the other during oscillation. FIG. 6C shows an alternative embodiment, in which the housing 22′ has a plurality of channels 37a-d. It should be noted that the piston rod 27 should be fitted through the hole 30″ of the alignment band 29″ prior to being fused with the piston head 31 or prior to being fused to the ring or yoke within which the crankpin or crankshaft turns.

FIGS. 6B and 6C show channels serving to equalize the pressures at the ends of the groove 36 in the housing within which the exterior alignment band oscillates or to shuttle lubricant back and forth across the interface. An alternative approach would be to not connect the groove ends and have pressure changes in the groove ends serve as pneumatic springs to lessen the mechanical forces needed to reverse the rotational momentum of the cylinder. This might be especially desirable in higher speed applications. The volumes and pressures involved in these springs could be variable so as to enable tuning to the speed of operation. The size and end profiles of exterior alignment bands might be deliberately chosen to help enable such pneumatic springs. In this case, the alignment band could be largely hollow or made of low mass materials to enlarge the effective “pistons” of such springs while adding little mass to the oscillating cylinder.

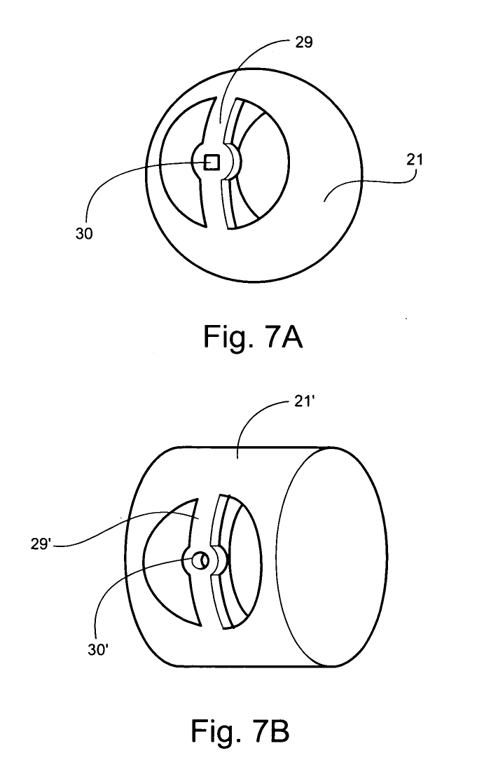

FIGS. 3B and 7B illustrate one embodiment of the oscillating cylinder suitable for smaller scale applications. The oscillating cylinder 21″ is a cylindrically-shaped disk with a cylinder hole bored in it. The cylinder 21″ does not need a bearing to hold it in place as it would be held in place by the housing 22, the piston head 31″ and the piston rod 27′ where it slides through the hole 30′ of the alignment band 29′.

An alternative and generally preferred simple embodiment is a spherical oscillating cylinder 21 such as shown in FIGS. 3A and 7A which is similar in shape to the ball in a ball valve. This shape inherently provides a center pivot bearing, and by reducing the mass away from the pivot points reduces the angular momentum of the oscillating cylinder.

For small scale applications, such simple shapes would likely be preferred, though even then an exterior alignment band might be opted for. For somewhat larger scale applications, a more complex mass-economizing shape would probably be preferred, such as the quasi-spherical shape of FIG. 3D.

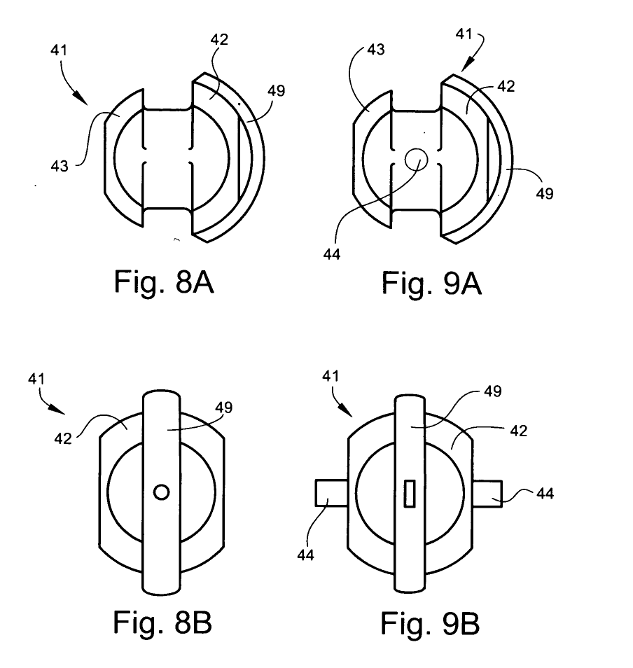

More complex still, an otherwise spherical cylinder could be further reduced in mass by eliminating much of the sphere where it is not necessary for strength, or to seal ports, such as shown in FIGS. 8A, 8B, 9A and 9B. The cylinder 41 can be a sleeve with fattened barrel ends 42, 43 which are spherical on the outside. The resulting profile would resemble an apple core where only the band around the middle has been eaten. Going even further, the fattened barrel ends could be largely hollow with the outside of the cylinder barrel and the spherical outside ends sealing the ports being connected by webs or buttresses.

The radiuses for the spherical ends 42, 43 of the cylinder 41 need not be the same. A larger radius on the crank end 42 would be consistent with a pivot point closer to the opposite end 43. This would enable larger ports on the crank end 42 which are otherwise restricted by the presence of the alignment band 49. If such a cylinder had a working volume only on the side most distant from the crank, a larger radius on the non crank end might be used to bring the pivot closer to the crank and enable larger ports relative to the working volume than would be possible in two sided operation.

The piston rod hole of FIG. 9B is shown as rectangular with the long dimension in the plane of oscillation. Such a shape for rod and hole would enable a narrower alignment band as seen from the crank. This would expand the area available for porting on that side.

FIGS. 9A and 9B show the cylinder 41 with trunnions 44 for providing explicit bearings at the pivot point. Here metal to metal contact between the cylinder and the embracing housing would be held in check by the bearings and not by the lubricant in the interface. Explicit bearings can insure more uniform clearances in the interface and thus allow the lubricant to more effectively restrain leakage across it or, alternatively, help enable oil-less operation. Although such bearings can serve as an aid to limiting leakage, it is presumed that the key feature of this invention, the embracement of the cylinder by the housing, is the primary restraint on leakage. This contrasts with the existing art such as represented in FIG. 1 where the “tightness” of the bearing at the pivot point, on which there can be reasonable leverage, is virtually the sole restraint on leakage.

It should be noted that use of explicit hearings does not require trunnions or other such additions. For example, ball or other bearings might be used in the interface with them embedded in pockets or cages in the housing or even in the cylinder itself. Alternatively, microscopic or “nanoscale” bearings might incorporated into the lubricant of the interface.

An alternative to the mass economizing shapes of FIGS. 8A, 8B,9A,9B would be to retain a simple outside profile of the cylinder, but with the space between the outside “shell” and the cylinder barrel being hollow or filled with a low mass material. If the space were hollow, it could have openings allowing a lubricant also serving as a coolant to get closer to the cylinder barrel. Flow of such a lubricant/coolant through hollow cavities in the cylinder could be actively provided from the housing embracing the cylinder.

A cylindrical or spherical shape of the housing embracing an oscillating cylinder is inherently strong. That strength, combined with its encompassing the moving cylinder would make it all but impossible for the cylinder 21 to be blown away from the inside surface of the housing 22 that embraces it. Sealing the housing 22 would make blow-by of the interface between the cylinder 21 and the embracing housing 22 that much more difficult and would permit the attainment of even higher pressures. Positive control of the pressure inside the housing 22 might be explored in the use of this invention. Pressure might be used not just to minimize blow-by, but also to offset the forces on the cylinder 21 across the ports 23-26 which are closed.

For example, if the cylinder 21 of FIG. 2 were used in a steam engine, the high pressure on the cylinder 21 at the closed entrance port 24 would be pushing the cylinder 21 in the direction of the closed exit port 25. That pushing might lead to more friction than is desirable between the cylinder 21 and the housing 22. The one sided force might be effectively balanced, without adding an explicit bearing, by strategically placed false opening(s), such as a pressurized opening at the bottom of the housing 22 of FIG. 2. The opening(s) can be pressurized with the medium driving, or being driven by, the piston or with a lubricant.

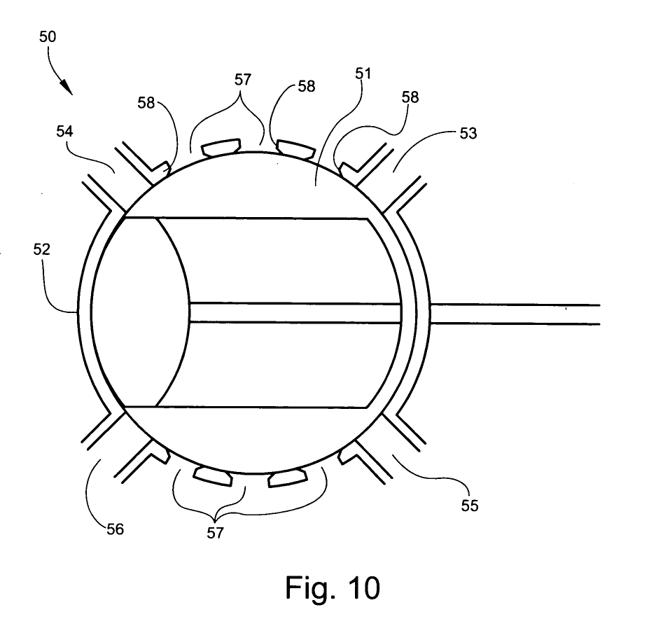

Another alternative is to have the pressurization through a grid of openings much like that used in air hockey games or the openings of a wiffle ball, such as in the embodiment illustrated in FIG. 10 and shown generally at reference numeral 50. Cylinder assembly 50 comprises an open ended cylinder 51 within a housing 52 that defines entrance and exit ports 53-56. The housing 52 also includes a grid of openings 57 through which lubricant can be supplied to the cylinder 51. The inner surface of the housing 52 has beveled edges 58 towards the oscillating cylinder 51 facilitating the drawing of lubricant into the interface between the oscillating cylinder 51 and housing 52. Having a grid of openings 57 in the housing 52 embracing the cylinder 51 would help eliminate the need for separate bearings in many applications. Lubricant can be provided to the cylinder 51 through these openings whether actively pressurized or not. Alternatively, an oil-less application might be enabled by providing pressurized air to the cylinder through these openings. With multiple such openings, an oscillating cylinder embraced by an inner housing within a larger pressure controlled container is preferable. The inner housing 52 for the cylinder assembly 50 serves very much like a cage for a ball bearing.

Where the oscillating cylinder has hollow cavities through which a lubricant/coolant flows, lubricant could be delivered to the cylinder—housing interface from the oscillating cylinder itself. There might be a hole or holes in the outside shell of the cylinder from which lubricant flows into the interface.

Pressure can be used in lubricating the inside of the cylinder 51. Check valves in the oscillating cylinder 51 can be used to bring lubricant into the cylinder 51 when the valve is on the low pressure side of the piston. The spherical shape of the cylinder shown in FIG. 3A would lend itself particularly well to installing check valves at the meaty pivot points.

The problem of throwing off lubricant is solved by containing the oscillating cylinder in a sealed housing. One housing can envelope multiple oscillating cylinders. End porting is easy to make very open and puts the intake and exhaust flows in line with the piston. Furthermore, it does not require a dead space at the ends of piston throws to accommodate holes on the sides of the cylinder.

This piston drive mechanism is simple both in the shapes and in the number of parts. In most applications, separate valving can be dispensed with. The number of independently moving parts per cylinder driving, or being driven by, the crankshaft or drive wheel is two: the piston with rod and the cylinder. Materials used need not be restricted to the metals traditionally used. Alternatives include amorphous metals, ceramics, Teflon, or various composites including carbon fiber and carbon-carbon, used with or without conventional lubricants.

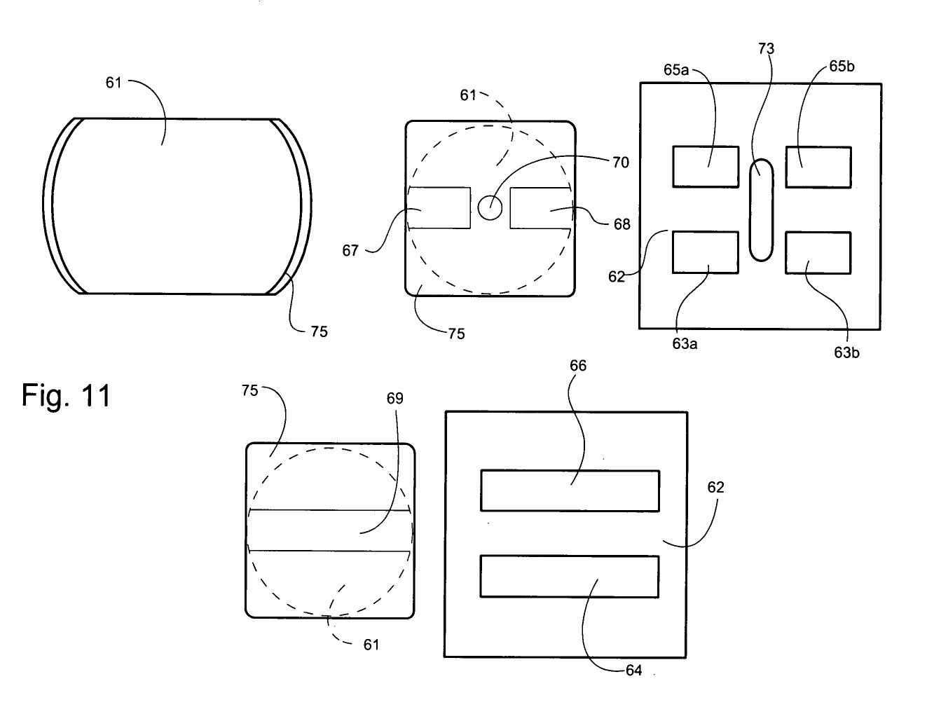

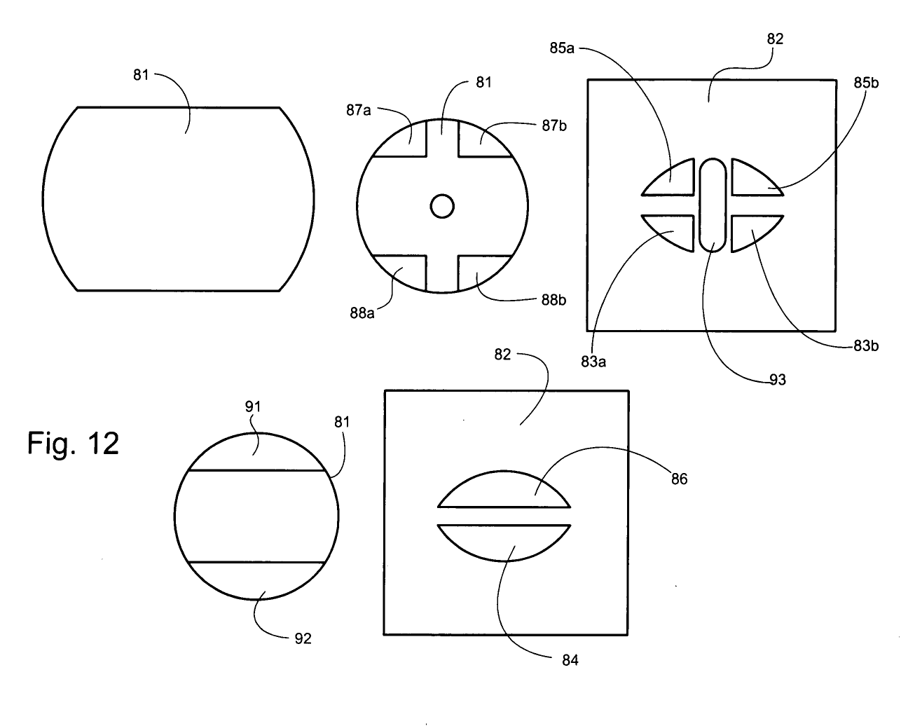

Still, other variants might be preferred in the largest scale applications. By using only a partially open end cylinder, a significant savings in weight is obtainable. Two alternative embodiments of the cylinder, cylinder ends and the corresponding housing ports are illustrated in FIGS. 11 and 12 for the case where the interface between cylinder and housing is cylindrical. Similar cylinder end and porting profiles would work for the spherical case. FIG. 11 illustrates a cylinder 61 with two rectangular apertures 67, 68 on opposite sides of a center hole 70 through which a piston rod is positioned. Rectangular apertures 67, 68 and center hole 70 are located on the crankshaft end of the cylinder 61. On the opposite end, cylinder 61 has one continuous rectangular aperture 69. A housing 62 has four rectangular ports 63a, 63b, 65a, 65b and a slot 73 that allows for oscillating movement of the piston rod on the crankshaft end of the housing 62. The outside of the housing 62 shown is consistent with a cylindrical interface. The opposite end of the housing 62 has two rectangular ports 64, 66. Each end of the cylinder 61 is connected to a square flange 75 to maintain sealing of the ports that are not being opened for flows when the other ports are opened. For example, as the piston rod oscillates upward, apertures 67, 68 on the cylinder 61 align with ports 65a, 65b. Meanwhile, the cylinder 61 and flange 75 maintain sealing of entrance ports 63a, 63b.

FIG. 12 shows a cylinder 81 with four apertures 87a, 87b, 88a, 88b, each in the approximate shape of quarter circles positioned in the crankshaft end of the cylinder 81. The opposite end of the cylinder 81 has two semi-circle shaped apertures 91, 92. A housing 82 has four ports 83a, 83b, 85a, 85b, each in the shape of quarter circles and a slot 93 allowing for oscillating movement of the piston rod, all located at the crankshaft end of the housing 82. Two semi-circle shaped ports 84, 86 are positioned on the opposite end of the housing 82. The embodiments shown in FIGS. 11 and 12 have a disadvantage in that they bring the ports on the housing 62, 82 closer together. However the larger scales which would motivate using such embodiments also makes dealing with that disadvantage easier, without compromising the strength of the housing. The embodiment of FIG. 12 would bring the greatest savings in weight at the cost of the tightest porting arrangement. Because these profiles have relatively small contact of the cylinders 61, 81 with the embracing housings 62, 82, respectively, and because of their larger scale, it is probable that explicit bearings at the pivot point would be used, such as with trunnions.

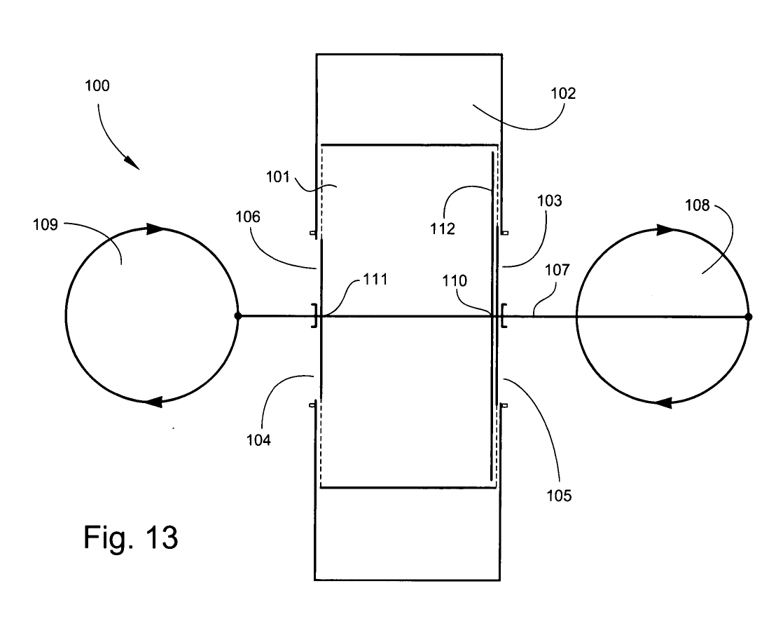

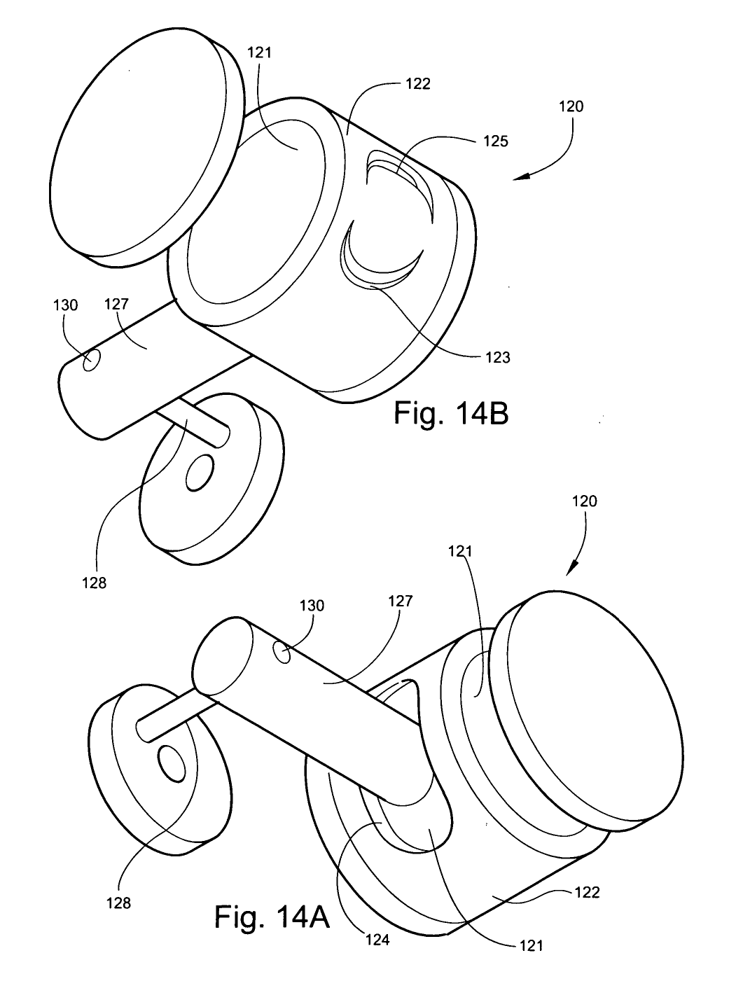

A related alternative to an end ported oscillating cylinder mechanism is an end ported linearly sliding cylinder assembly illustrated in FIG. 13, and shown generally at reference numeral 100. The sliding assembly 100 comprises a cylinder 101 positioned within a housing 102 for linear sliding movement. Center holes 110 and 111 are located on opposite ends of the cylinder 101. Entrance ports 103, 104 are located diagonally opposite on the housing 102. Exit ports 105, 106 use the remaining diagonally opposite port positions. The ports 105-106 are segmented around piston rod slots at both crank ends of the housing 102 in the same pattern as the crank end pattern of FIG. 12. With necessary changes being made in ports and cylinder end profiles, the crank end patterns of FIG. 11 could also be used. A piston rod 107 is connected at opposite ends to two crankshafts 108, 109 and is positioned through piston rod slots in the housing 102 and center holes 110, 111 in the cylinder 101. A piston head 112 is connected to the piston rod 107. Rotation of the crankshafts 108, 109 in unison moves the piston rod 107 and piston head 112, which imparts linear motion on the cylinder 101. The linear motion of the cylinder 101 within the housing 102 opens and closes the entrance and exit ports 03-106 by intermittently aligning apertures in the cylinder 101, shown in phantom, with the ports 103-106.

Cylinder assembly 100 could have been useful in steam locomotives where single cylinders were used to power up to 5 driving wheels. The piston rod and the main rod connecting the driving wheels would be one. A disadvantage of this cylinder assembly 100 is that keeping the piston rod slots sealed requires a cylinder 101 with a radius twice that of the wheels or cranks to the crankpins. In a locomotive, any design would have to achieve the appropriate clearance beneath the wheels. Other disadvantages are that a larger housing 102 for the moving cylinder would be required, that its rectangular shape is not as inherently strong as the round shapes of the oscillating cylinder assemblies of this invention, and that it requires two cranks.

All the assemblies have been shown with pistons touching the chamber walls. Of course with necessary changes in clearances, the interface between the piston and the cylinder chamber wall could be bridged with piston rings.

The invention includes several versions of end ported moving cylinder mechanisms. The oscillating cylinder versions would be more generally useful.

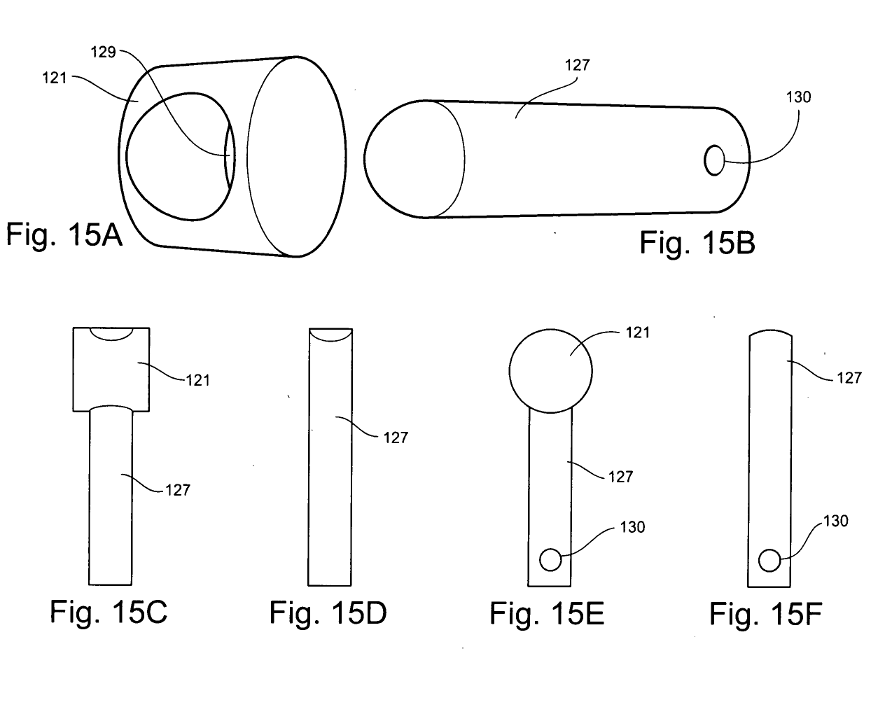

One sided versions of the oscillating cylinders are particularly simple to manufacture for small scale. A one sided cylinder assembly according to the invention is illustrated in FIGS. 14A and 14B, and shown generally at reference numeral 120. The one sided cylinder assembly 120 comprises a cylindrically shaped cylinder 121 embraced by cylindrically shaped housing 122. The housing 122 has a slot 124 that allows for oscillating movement of a piston 127 connected to a crank 128. On the side opposite of the crank 128, the housing 122 has crescent shaped entrance and exit ports 123, 125, respectively. As shown in FIG. 15A, the cylinder 121 has an aperture 129 going all the way through thereby eliminating the need for an alignment band at one end of the cylinder 121. The matching piston 127 has the same diameter as the cylinder aperture 129. In that case, the piston 127 need be nothing more than a simple round rod with a hole 130 for the crankpin or crankshaft 128, as shown in FIGS. 14A and 14B.

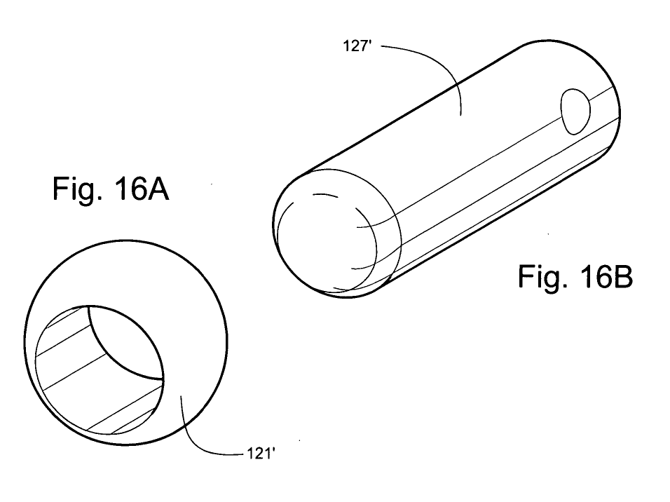

Alternatively, the piston and crankpin could be formed in one piece with the pin fitting into a driving, or driven, disk or wheel. As shown in FIG. 15B, one end of the piston 127 is preferably shaped to conform to the contour of the inner surface of the housing 122. In an alternative one-sided embodiment, the cylinder 121′ is spherical as shown in FIG. 16A. In such an embodiment, the housing is also spherical, and the piston 127′ has an end shaped to be flush with the outside of the cylinder 121′, as shown in FIG. 16B, and conform to the spherical shape of the inner surface of the housing with full extension into the cylinder 121′. In many miniature applications, the ease of fabrication for one sided versions might outweigh the dead cylinder space created. This would be especially likely for pumps and compressors where maintaining rotational momentum through a non power phase is not an issue.

In 1999 and again in 2002, there were NASA/JPL sponsored conferences devoted to solving the need for miniature vacuum pumps. Existing art oscillating cylinders probably would not lend themselves well to use as a vacuum pump. The vacuum would draw the mating surfaces containing the ports together either seizing the pump or requiring great power to run.

This would not be the case with the oscillating cylinder mechanism of the present invention. The housing would have to be more substantial for a vacuum pump than for a high pressure pump to resist the pressures working to squeeze the housing around the oscillating cylinder. However, subject to this requirement, the present invention could be used in a vacuum pump.

Furthermore, a conventional rotary motion driven piston vacuum pump is prone to certain difficulties not affecting the present invention. Under high vacuum, the piston has high forces pushing it against one side of the cylinder making leaks hard to resist, inducing high wear and requiring high power to run. This invention is free from this drawback. This point would also apply to high pressure applications, suggesting that unlike the existing art, the oscillating cylinder mechanism of the present invention should permit the attainment of higher pressures as well as greater vacuums. Also, the spring loaded flaps or reed valves used in many pumps and compressors would not operate with very low pressures. Open passageways are required, the more open the better. Without flaps, a conventional piston pump would require valves, an additional barrier in miniature applications. Another issue in a vacuum pump is the ability to completely empty the cylinder on the expelling stoke. Any voids at the fullest extent of that stroke will limit the vacuum that can be obtained. In this invention, matching the end of the piston to the inside of the housing will eliminate any void. Applicant is unaware of any other designs that can so simply and effectively eliminate voids. The oscillating cylinder mechanism of the present invention is superior to conventional piston pumps in such applications.

The potential uses of this invention in steam or other external combustion engines, compressors, pumps and vacuum pumps are straightforward. Its potential use in internal combustion engines is less so. However, its use in one possible two stroke engine is very similar to its use in an external combustion engine.

The engine relies on a powerful compressor or supercharger to achieve the compression usually accomplished in the first two strokes of a four stroke engine. The Wankel rotary device is one mechanism capable of delivering sufficiently high compression. The engine is envisioned using an open end oscillating cylinder of the types offered above. The preferred embodiment in most applications is assumed to be spherical or a variation thereof, such as that shown in FIG. 3D. Other embodiments could be used without changing the operation of the engine. The two strokes are power and exhaust just as in a conventional steam engine.

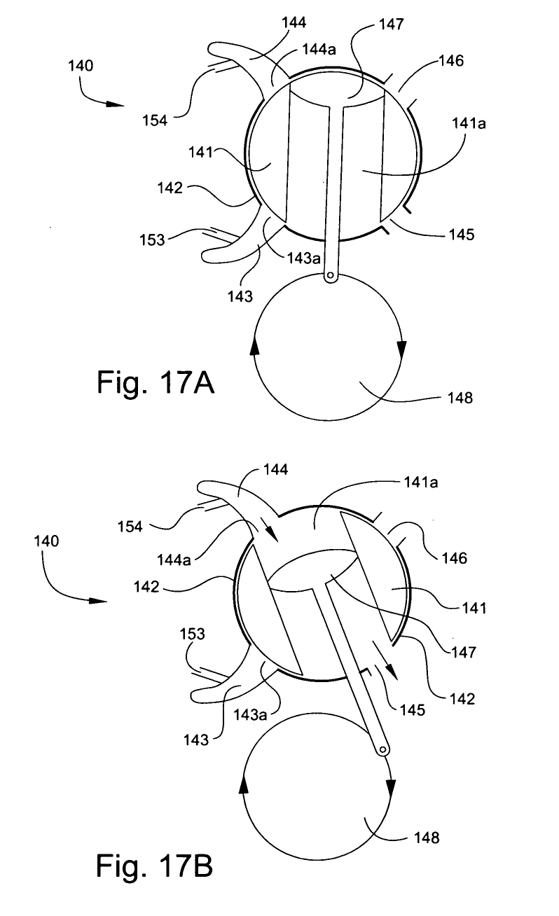

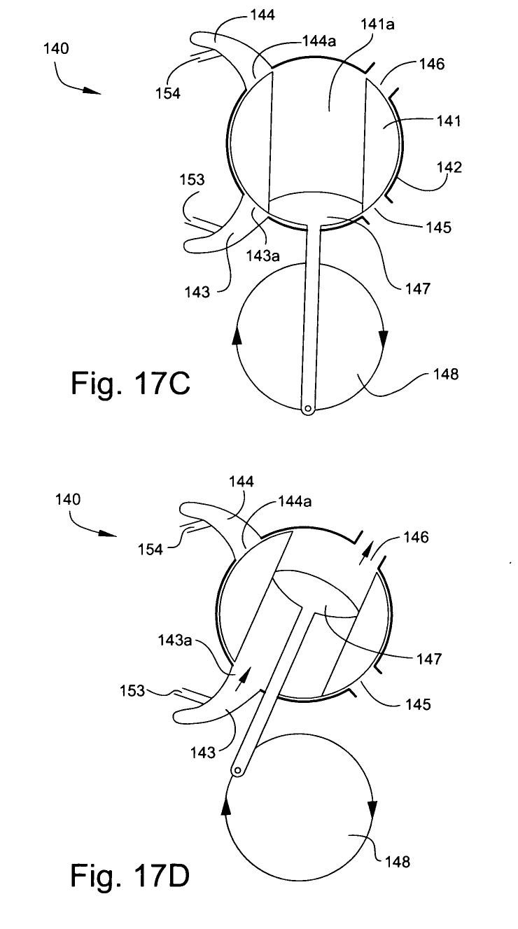

The working of the engine 140 is illustrated in FIGS. 17A-D. The cylinder 141 oscillates in a housing 142 such as to open up to ignition chambers 143, 144 during the power strokes and to exit ports 145, 146 during the exhaust strokes. The compressed air from the supercharger feeds the ignition chambers 143, 144 via delivery tubes 153, 154. Some point in the ignition chambers 143, 144 will be where combustion starts either by spark or by injection of fuel into highly compressed air. The flame front will move from that point to the opening of the ignition chambers 143a, 144a into the cylinder chamber 141a and powering the piston 147 which is connected directly to the crankshaft 148. The ignition chambers 143, 144 are shown in FIGS. 17A-D to have an illustrative horn shape. Illustrative because the horn would become widest in the dimension perpendicular to the plane of the FIGS. 17A-D. The opening of the ignition chambers 143a, 144a into the cylinder is crescent shaped with the crescent longest in the perpendicular dimension, as shown in FIG. 5B. A horn shape is assumed preferred to allow a flame front to develop most smoothly before entering the chamber 141a of the cylinder 141. It is assumed that ignition would be initiated at the narrowest part of the horn and that the flame front would move to the wider parts of the horn as it grows. Other shapes of the ignition chambers 143, 144 are possible. For very small scales, a horn shape would not be desirable once the narrowness of a horn begins to interfere with successful flame propagation. A more bulb shaped ignition chamber is likely desirable for such scales.

Ceramic or other thermally insulating coatings or inserts would help prevent flame quenching in the ignition chamber whatever its shape. Since there is no mechanical contact with the ignition chamber's surface, surface cracks or other imperfections are of little concern provided there is no sloughing off of material which might damage the downstream parts. Such coatings or inserts would increase the thermal efficiency of the engine as would a similar coating on the piston head.

Flow during the power stroke is prevented from backing up towards the compressor or supercharger by a check valve or by having the compressed air from the supercharger enter the ignition chambers 143, 144 at an angle designed for there to be a Venturi effect with the passage of the flame front such as to prevent a backward flow. The power stroke is shown in FIG. 17B and the exhaust stroke in FIG. 17D for the upper working volume and vice versa for lower working volume. An alignment band is not shown in FIGS. 17A-D so as not to obstruct the visualization of the flows. With spark ignition, fuel can be injected into the ignition chambers 143, 144 near bottom dead center and top dead center for the upper and lower working volumes so as to give the maximum time for mixing of fuel prior to spark. Introducing fuel prior to the closing of the ignition chamber openings 143a, 144a to the cylinder chamber 141a would not generally be desirable because of the potential contamination of the exhaust.

It should be mentioned that this invention can also be used in a 2-stroke engine of the type generally used in chain saws, trimmers, snowmobiles and outboard engines. The cylinder could be similar to the embodiments presented above but the housing, unlike the other embodiments, would not be end ported. The entrance and exit ports, as in existing art 2-strokes of this type, would be on the cylinder sides such as to be revealed to the cylinder as the piston reaches bottom dead center. The cylinder would also have to have passageways on the sides such as to line up with the ports in the housing at the appropriate time permitting flows into and out of the cylinder. Here the invention does not offer any mechanical simplification. The piston head and piston rod are made one but at the expense of requiring the cylinder itself to move. Use of the invention in such engines, however, would eliminate the unbalanced forces against the cylinder walls, especially under heavy loads. Higher compressions would be feasible and cylinder wall lubrication requirements would be less.

The use of the invention in such 2-cycle engines is not expanded upon because of the likely bleak future such engines have due to environmental reasons. This is especially so given that such 2-stroke engines, which are necessarily one sided in operation, offer no space or weight savings over the two-sided 4-stroke embodiments of the invention presented below. Furthermore these 4-stroke embodiments should be quieter, smoother running, easier to start and have a wider useful power bandwidth. Only in the most miniature applications might such a 2-stroke be the preferred embodiment.

A pair of cylinders of the type described above can be used to make a four-stroke engine. This engine offers substantially simpler mechanics and offers easy ways to achieve things which are currently at the frontier of engine design art. There are two basic embodiments. One uses one sided oscillating cylinders and involves the same number of power strokes per cylinder as the existing art. The second uses two sided oscillating cylinders and has twice the power strokes per cylinder as the existing art.

The second embodiment is presumably more difficult to manufacture, but offers space and weight savings as well as a reduction of the losses incurred in reversing the momentum of reciprocating parts. The second embodiment itself has two versions. In one version, compression and power strokes occur together within each cylinder on different sides of the piston. Here, with the power stroke driving compression on the other side, the size and strength of the piston rod and the crankshaft need not be as great. In the second version, compression and power strokes are not mated within the cylinders, but occur with intake and exhaust strokes, respectively, in dedicated cylinders. Though generally not as compact, this second version is more flexible in design.

In some embodiments, one of the cylinders in a cylinder pair can be larger than the other. In doing that, expansion volumes larger than the compression volume can be achieved without artificially reducing the compression volume by late closing of the intake valves. This is a more efficient way to achieve the benefits obtained from so-called “Miller” or “Atkinson” cycle engines.

In addition, the invention offers an easy method to achieve variable port timing to widen the useful power bandwidth of the engine. Means to minimize throttle losses are discussed as well as how the invention can reduce the losses in continuously reversing the momentum of parts that reciprocate.

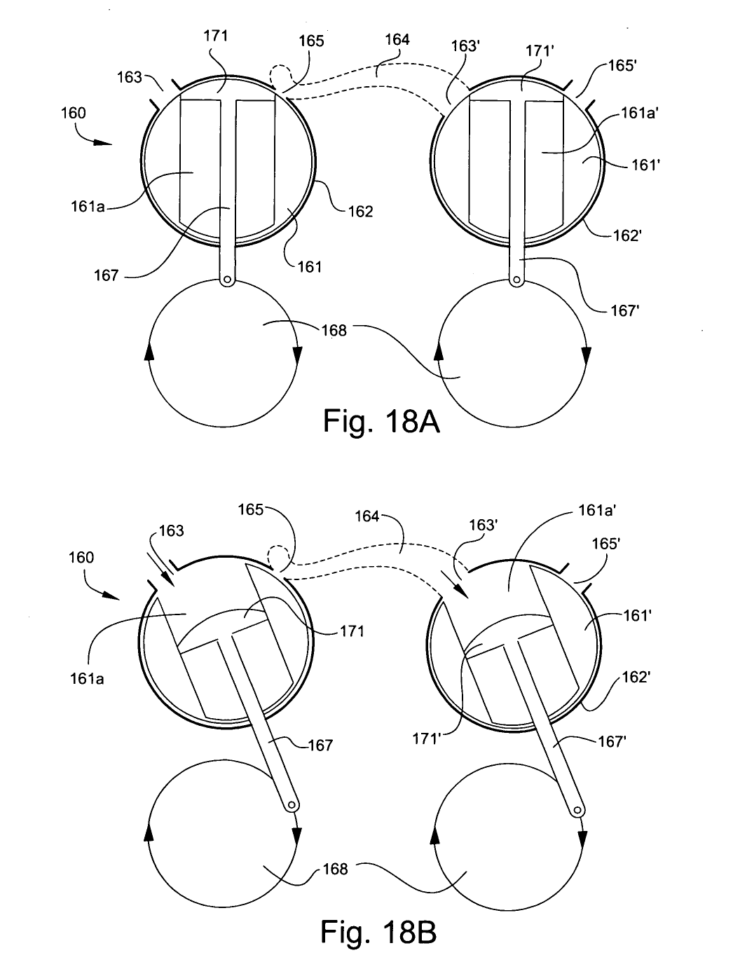

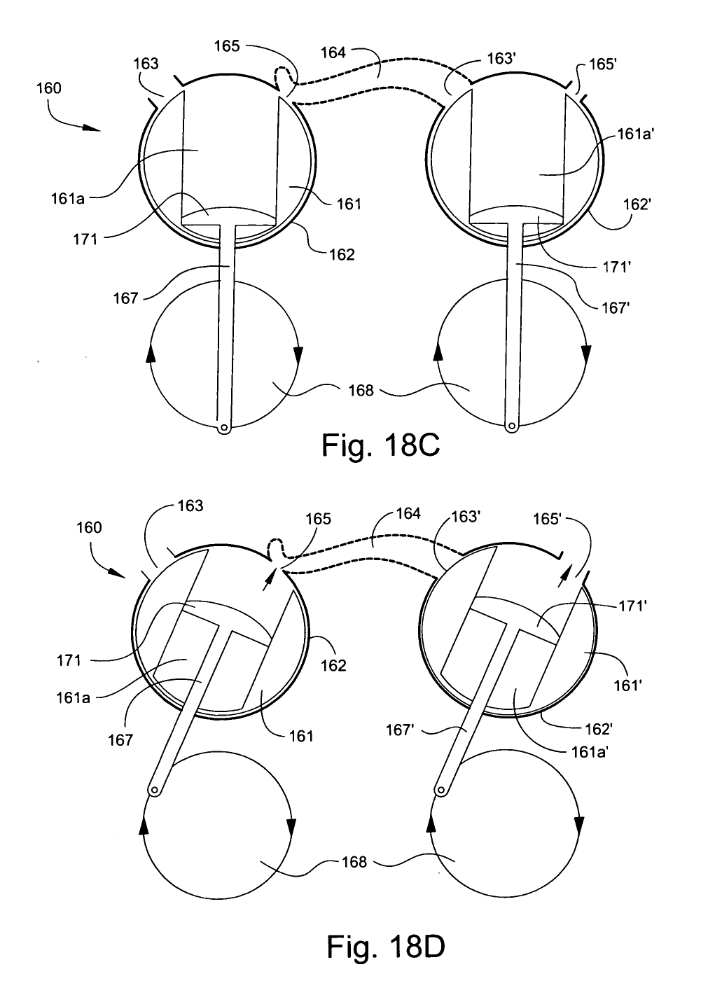

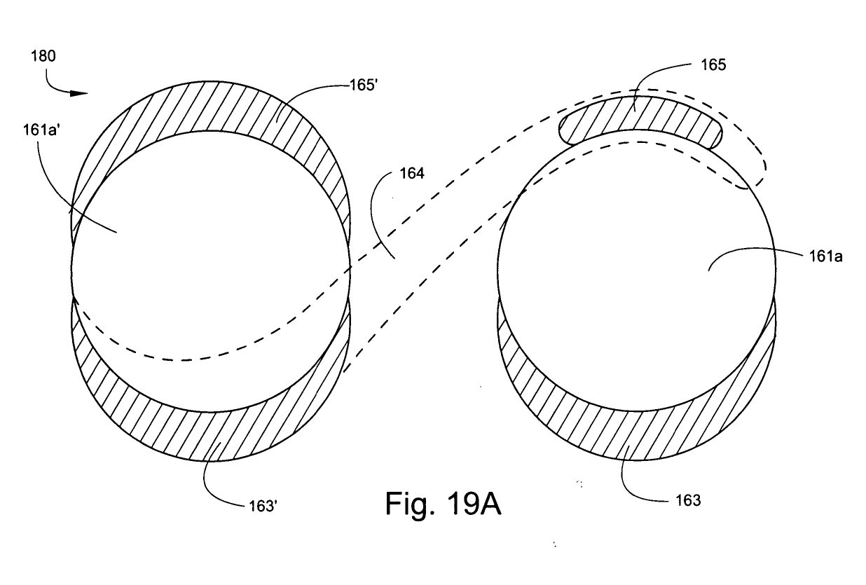

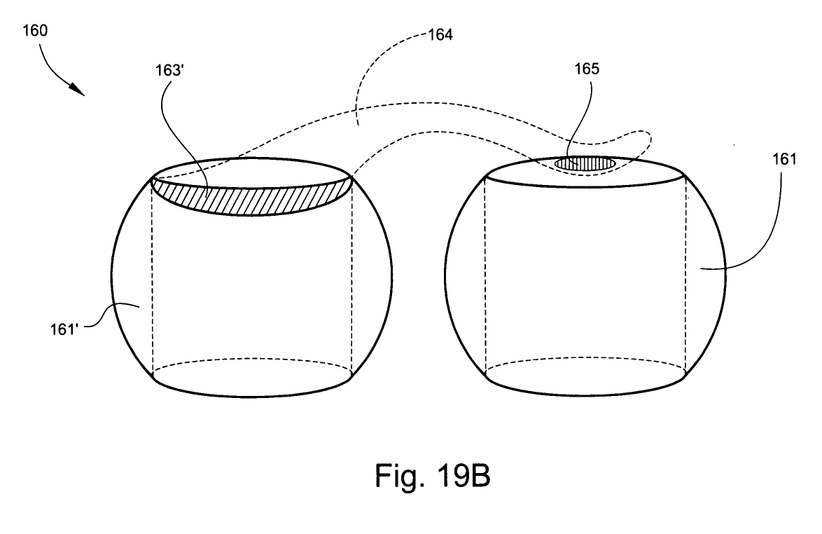

The one sided version is illustrated in FIGS. 18A-D, and shown generally at reference numeral 160. This embodiment of the invention uses a pair of cylinders 161, 161′ each with 2 strokes, to accomplish what the existing art accomplishes in one cylinder with 4 strokes. In terms of power strokes per cylinder, it is equivalent to the existing art. The cylinders 161, 161′ are positioned for reciprocal rotational movement within housing sections 162, 162′, respectively. The paired cylinders 161, 161′ share a single position on a crankshaft, and receive piston heads 171, 171′ with rods 167, 167′ respectively. One cylinder 161 performs intake and compression steps while the other cylinder 161′ performs power and exhaust steps. The first housing section 162 includes an entrance port 163 and an exit port 165. The second housing section 162′ has an entrance port 163′ and an exit port 165′. A passage 164 connecting the two cylinders 161, 161′ is shown with dashed lines because it traverses the space between the planes of the FIGS. 18A-D showing the positions of the two cylinders 161, 161′. The passage 164 serves as the ignition chamber for the power stroke which occurs in the second cylinder 161′. The true shape of the passageway 164 between an in-line pair of cylinders 161, 161′ is illustrated in FIGS. 19A and 19B from the vantage of two different perspectives. The passage between the cylinders 161 and 161′ could run within the housing embracing both cylinders, through a tube external to the housing or run along the interface between the cylinders and the housing. The exit port 165 for the first cylinder 161 is shown smaller while still preserving the crescent shape. The thinner exit is in keeping with a horn shaped ignition chamber 164. Also, compressed air should not need as large an exit to move quickly through. The horn shape is preferred again for coherent development of the flame front. The fuel is mixed prior to intake, injected into the first cylinder 161 prior to, or during, compression or injected directly into the ignition chamber 164. The ignition can be accomplished either by spark, or by high compression as in a Diesel. The size of the ignition chamber 164 determines the compression ratio. The size can be adjustable so as to accommodate different fuels in the same engine, to optimize performance under different operating conditions, or to provide for easier starting.

Again, other shapes of the ignition chamber 164 are possible. Also, the ignition chamber and the passage between the cylinders could be separate with flows perhaps additionally controlled by one or more check valves. For very small scale engines, ignition would generally be moved closer to the ignition chamber's port entrance 163′ on the second cylinder 161′. This would avoid the issue of flame propagation through too narrow spaces. In this case, a more bulb shaped ignition chamber near the entrance 163′ to the second cylinder 161′ combined with a separate passage from the first cylinder 161 would be preferred. Check valves on this scale would not only be difficult but would likely serve little purpose as combustion is effectively prevented from entering the passageway by its narrowness.

Scaling down even further, any ignition chamber outside of the second cylinder 161′ may be a barrier to ignition. In that case, a simple passageway from the first cylinder 161 to the second cylinder 161′ would be appropriate along with bringing the first cylinder 161 to top dead center after that of second cylinder 161′. This would mean the compressed gas is transferred to the second cylinder 161′ and ignition is delayed until the volume of the second cylinder 161′ is sufficiently large to sustain combustion. The resulting power phase is shortened. The theoretical scale limit of such a combustion engine is reached when the power phase is too short to obtain useful work from it. These comments would also apply to the engine presented above where compression is accomplished with a supercharger alone. In such an extremely scaled down version, the supercharger or compressor would feed directly into the cylinder and the power phase would be shortened. Ceramic coatings or inserts would presumably keep all these scale limits as small as possible.

It should be noted that the crescent shaped ports 163, 163′, 165, 165′ open to and introduce flows along one side of the cylinders 161, 161′. This inherently induces a tumbling action within the cylinders 161, 161′. This will aid in any mixing of fuel with air in the first cylinder 161 and will facilitate combustion in the second cylinder 161′. The ignition chamber 164 in crossing over from the first cylinder 161 to the second cylinder 161′ will additionally induce a swirling action, during the power stroke, in the second cylinder 161′, which may in fact dominate. Different manifold and ignition chamber shapes could be explored with the aim of inducing even greater turbulences.

By sharing a basic position on the crankshaft, the distance of the passageway between the cylinders 161, 161′ can be kept short. The compression exit from the first cylinder 161 and the power entrance to the second cylinder 161′ are on opposite sides—respectively right and left in FIGS. 18A-D and top and bottom in FIG. 19A. By having a slight offset or vee relation to the crankshaft, the passage could be made more in line with the crankshaft and thereby shorter. An offset would also enable cylinders with a spherical shape, or with trunnions, to be slightly closer together at the crankshaft, because the widest parts of the cylinders are not then in line. Also, an offset could help in keeping the cylinder housing at the cylinders” open end free for the type of controls introduced below.

Manufacture of the housing incorporating sections 162, 162′ which could also include the passage between the cylinders 161, 161′ might involve casting around forms for the appropriate spheres, or other shape, for the cylinders, and the ignition chamber 164. The volume of material making the form of the ignition chamber 164 would be dictated by the compression ratio sought.

The cylinders 161, 161 ′ include alignment bands at the cylinder bottoms such as illustrated in FIGS. 3A or 3B. An alternative is to have a sufficiently large piston head to insure that the rocking motion is imparted to the oscillating cylinders 161, 161′. If conventional rings are used with such a head, they must be sufficiently spaced so as to keep the piston heads 171, 171′ properly aligned within the cylinders 161, 161′. With working chambers on only one side of the piston heads 171, 171′, air must be able to move freely in and out of the bottom sides of the cylinders 161, 161′.

It should also be noted that FIG. 18A shows no dead space between the piston heads 171, 171′ and the cylinders” housings 162, 162′, respectively, at top dead center. In practice, that limiting case may not be desirable due to mechanical tolerances and the need to prevent excessive squish velocities and pressures. To avoid the latter, slightly less convex piston heads might be appropriate, especially in higher rpm applications.

The advantages of this engine over conventional engines are many. Foremost among them is its great mechanical simplicity. The number of independently moving parts per cylinder is two; the piston with rod and the oscillating cylinder. The only other necessary moving part, exclusive of fuel delivery and any spark ignition, is the crankshaft-flywheel assembly. This simplicity along with an uncrowded cylinder housing will permit a variety of controls, as described below, which are becoming harder and harder to add onto the increasingly busy cylinder heads of conventional engines. Where there is only one position on the crankshaft for the two cylinders, the crankshaft is thereby simpler. In addition, the second cylinder 161′ could be made larger than the first cylinder 161 to make the expansion volume larger than the compression volume. This is a more efficient way to capture the gains of so-called “Miller cycle” or “Atkinson cycle” engines than artificially reducing the compression volume by late closing of the intake valves. These engines limit the compression volume by pumping intake back out into the intake manifold. The wasted pumping is not costless. Furthermore, the first cylinder 161 can be brought to top dead center before the second cylinder 161′, allowing compression to be completed prior to ignition and more time for combustion to be completed. Staggering the timing of the top dead center position would also limit vibration in engines which are not inherently balanced. It should be noted that a vee or offset relation of the cylinders discussed above would as a consequence advance top dead center in the first cylinder 161 ahead of the second cylinder with the cylinders 161, 161′ still sharing an identical position on the crankshaft. Finally, having the piston move in line with the crankshaft at the point of most efficient transfer to rotary motion and without the piston having to fight the cylinder walls should be more efficient and better wearing than existing art conventional engines.

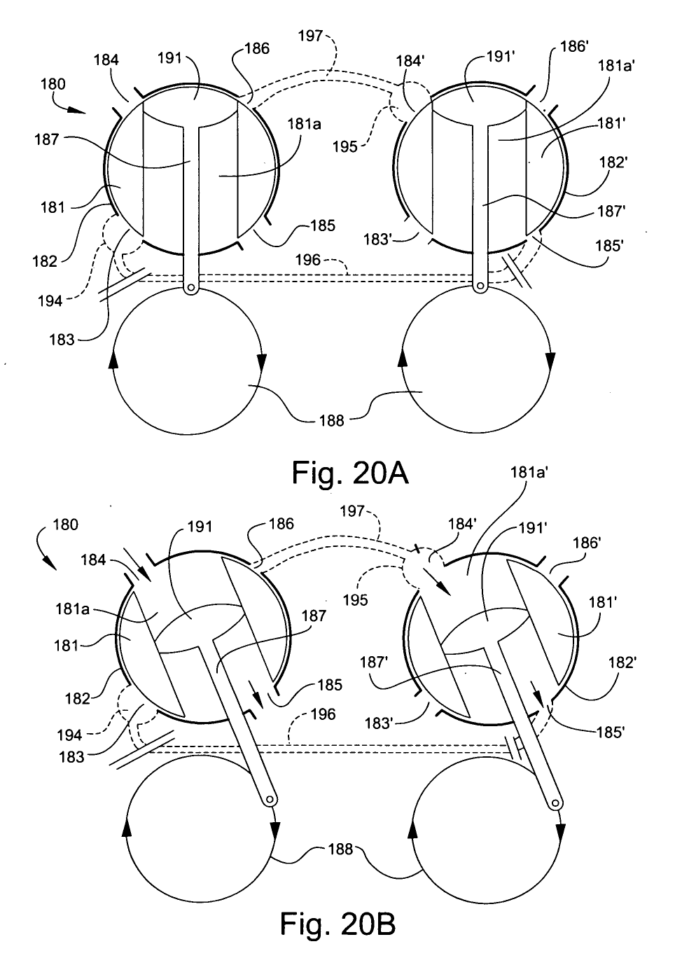

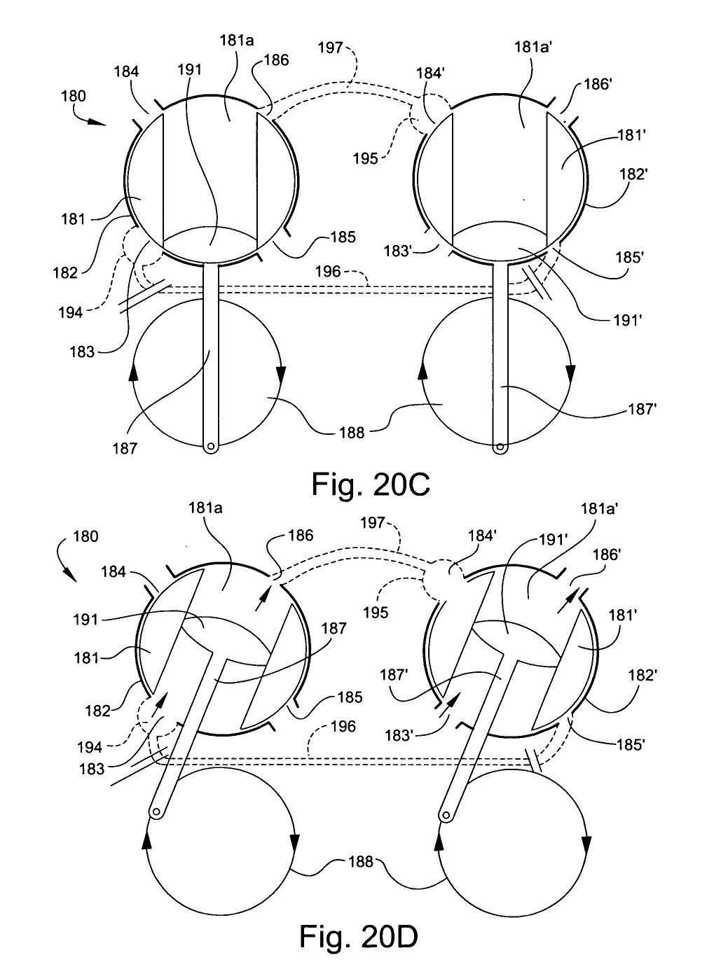

One two sided embodiment is illustrated in FIGS. 20A-D and 21A-C, and shown generally at reference numeral 180. A pair of cylinders 181, 181′ again is used to accomplish what conventional engines do in one cylinder. However, since each cylinder 181, 181′ does two strokes on each side of the piston in one revolution, the pair of cylinders 181, 181′ is the functional equivalent of a 4-cylinder conventional engine.

The cylinders 181, 181′ define cylindrical chambers 181a, 181a″, respectively, and are positioned for reciprocal rotational movement within housing sections 182, 182′, respectively. Each housing section 182, 182′ includes a pair of entrance ports 183, 184, 183′, 184′, respectively, and a pair of exit ports 185, 186, 185′, 186′, respectively. The operation of the top sides of the cylinders 181, 181′ in FIGS. 20A-D are the same as the one-sided cylinders 161, 161′ in FIGS. 18A-D. The bottom sides of the cylinders 181, 181′ are functionally the same as the top sides. The cylinders 181, 181′ are connected to each other by two ignition chambers 194, 195 and the passages 196 and 197, One ignition chamber 194 communicates with one entrance port 183 of the first cylinder 181 and, through the passage 196, with the exit port 185′ of the second cylinder 181′. The other ignition chamber 195 communicates with entrance port 184′ of the second cylinder 181′ and, through the passage 197, with the exit port 186 of the first cylinder 181, The passage 196 on the bottom side is shown in FIGS. 20A-D as being discontinuous. This is only to avoid the impression that the passage 196 on the bottom is longer than the passage 197 on top. It is not.

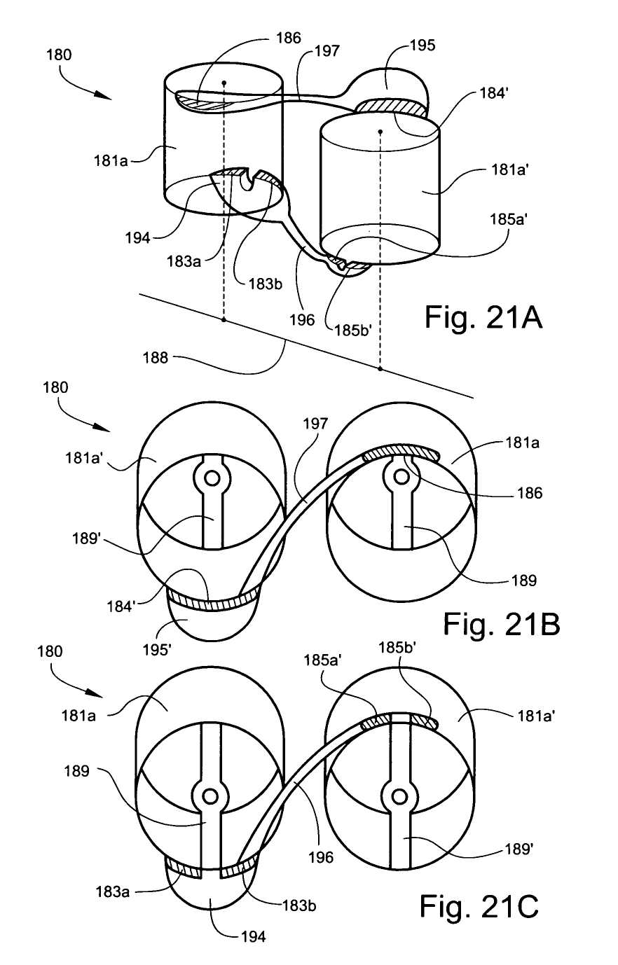

FIGS. 20A-D also show the ignition chambers 194, 195 being bulb shaped at their entrance to the power stroke working volumes with the chambers 194, 195 being fed by simple passageways 196, 197, respectively, from the compression stroke working volumes. This is because this engine embodiment 180 lacks the flexibility which would favor use of a horn shaped ignition chamber, by allowing shorter passageways between cylinders and extra time for combustion. The cylinders 181, 181′ cannot be offset to reduce the length of the passageways 196, 197. An offset would lengthen the passageway on one side as it reduces it on the other. Additionally, one of the cylinders 181, 181′ cannot be brought to top dead center before the other. To do so would advance completion of compression prior to the beginning of the power stroke on one side of the pistons, but at the expense of retarding completion of compression after the beginning of the power stroke on the other side. With such inflexibility, it is likely desirable to begin ignition closer to the entrance to the power stroke working volume to limit the distance the frame front must traverse during the power stroke. This is accomplished with the illustrative bulb shapes of the ignition chambers 194, 195 shown in FIGS. 20A-D. The perspective views of FIGS. 21A-C show the true orientation of the chambers 194, 195 and passageways 196, 197 relative to the cylinders barrels positions at top dead and bottom dead centers.

Alternative combustion scenarios in the ignition chambers 194, 195 and passageways 196, 197 exist. The passageways 196, 197 could be too narrow for combustion to enter from the ignition chambers 194, 195. As pressure drops during the latter part of the power stroke, some intake in the passageways 196, 197 flows into the ignition chambers 194, 195 and power stroke volumes to be burnt during later the phase of combustion. If the passageways 196, 197 are not too narrow to sustain combustion, the pressure rise in the passageways 196, 197 from combustion is eventually transferred to power stroke volumes during that stroke. Presumably though, it would be preferable not to have combustion enter the passageways 196, 197. To accomplish that, the passageways entrance to the ignition chambers 194, 195 could have a check valve, shield or narrowed throat designed to prevent combustion from entering the passageways 196, 197. Another possibility is for the ignition chambers 194, 195 port openings to the power stroke volumes 183, 184″ and the passage entrance to the ignition chambers 194, 195 to be designed so as to promote the flame front's passing the passageway entrance in a way and angle that combustion does not enter the passageways 196, 197 and intake in the passageways 196, 197 is drawn into ignition chambers 194, 195 and power stroke volumes after the initial passage of the flame front (via the Venturi Effect). Intake thus drawn into the ignition chambers 194, 195 and power stroke volumes is burned during the later phase of the power stroke. Any issues of incomplete combustion and fuel contamination of the exhaust from all this can generally only arise where fuel is introduced prior to the passageway entrances to the ignition chambers 194, 195. A check valve at the passageway entrances to the ignition chambers 194, 195 chosen to hold back flow once pressure drops to a critical level could also avoid any problem.

The alignment bands 189, 189′ for the cylinders 181, 181′ are not shown in FIGS. 20A-D so as not to obstruct the visualization of flows. The existence of alignment bands 189, 189′ is one of several minor asymmetries between the two working chambers on the two sides of the pistons. The bands 189, 189′ limit the space on the housing sections 182, 182′ available for porting, although as noted above that can be compensated for by the cylinders 181, 181′ having a larger radius from the pivot points on the crankshaft side. As shown in FIGS. 21A and 21C, the bottom side passageway 196 would have two points of entrance 185a″, 185b″ from the second cylinder 181′ straddling its alignment band 189′ and the bottom side ignition chamber 194 has two points of exit 183a, 183b into the first cylinder 181 straddling its alignment band 189. The piston rods 187, 187′ themselves occupy part of the working chambers on the crankshaft side. Additionally, on the crankshaft side, the most efficient position to transfer force to the crankshaft 188 is reached after the piston heads 191, 191′ have traveled half way through the cylinders 181, 181′, respectively. On the opposite side the opposite is true. A two-sided engine would have to accommodate these asymmetries in its design. The ignition chamber 194 on the crankshaft side is smaller, in line with the smaller working volumes. Some difference in ignition timing may be appropriate in line with different points of most efficient power to the crankshaft 188. However, points of optimal timing are presumably mostly a factor of the shape of the ignition chamber 194, the point of ignition, as well as engine speed.

There are several advantages of this two sided version 180 compared to the one sided embodiment 160. It allows essentially a doubling of power with no increase in size or number of moving parts, or the total energy lost to reversing the momentum of reciprocating parts. Also, the power stroke in each cylinder 181, 181′ drives the compression stroke on the other side of the piston. With the piston rod 187, 187′ and crankshaft 188 only having to transfer power net of compression, their required masses are somewhat reduced. This helps compensate for a housing 182 sufficiently larger to accommodate the additional ignition chamber 194 on the crankshaft side. The engine is smoother running, easier to start and requires a smaller flywheel, saving additional weight. In hand-started engines, the easier starting feature helps enable use of higher compression ratios with resulting increases in power and efficiency. Naturally, the number of pistons scraping cylinderwalls is halved compared to equivalent one-sided engines, with a reduction in such friction.

The disadvantages include slightly more difficult manufacture and more heat generation. However, with ignition occurring in the stationary ignition chambers 194, 195, the heat generation in the cylinders 181, 181′ themselves should be slightly less than in a conventional two stroke engine.

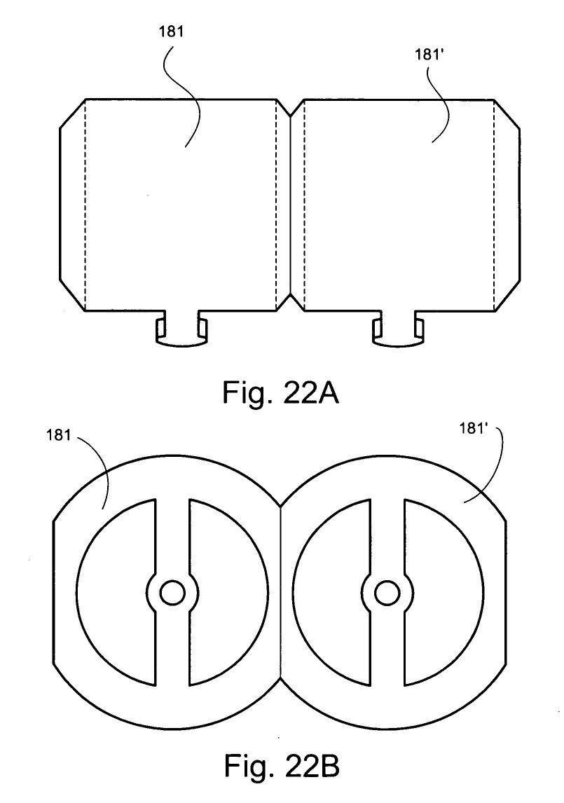

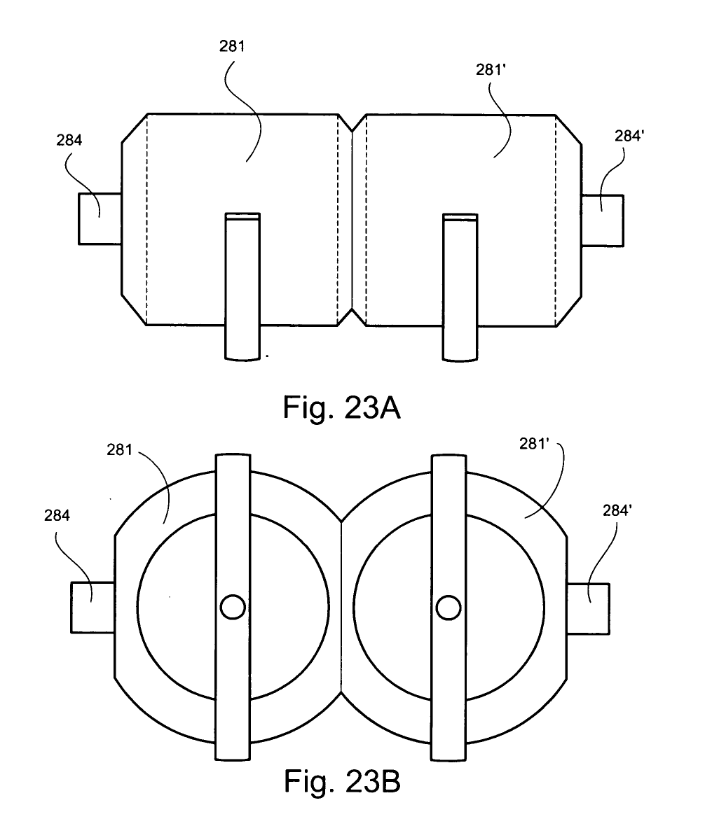

It was noted above that the cylinders 181, 181′ of this two sided engine cannot be offset to reduce the length of the passageways 196, 197 between them. With the cylinders necessarily in line, the two cylinders 181, 181′ can be made as one piece with additional savings in weight obtainable from the sharing of a single wall between the cylinder barrels 181a, 181a′. FIGS. 22A-B illustrates a one piece cylinder pair shaped for minimum weight. FIGS. 23A-B illustrates another one piece cylinder pair comprising a pair of cylinders 281, 281′ with alignment bands 289, 289′ positioned on the exterior, and the addition of trunnions, 284, 284″, as shown in FIG. 3D and 9B. The position of the cylinder barrel sides are shown in phantom in FIGS. 22A and 23A.

Another disadvantage of the two-sided engine arrangement 180 is that it is not possible to make one cylinder larger that the other. A larger expansion volume than compression volume on one side of the pistons achieved by varying the cylinder sizes has the reverse effect on the working volumes on the other side.

This two-sided engine 180 lacks some of the flexibility possessed by another two-sided engine presented below. Nevertheless, because of the savings in weight and compactness of having the cylinders in line, this engine 180 may be the preferred embodiment for many applications, such as in chain saws, trimmers, hobby engines, and small lawn mowers, as well as in powering portable generators, compressors and pumps.

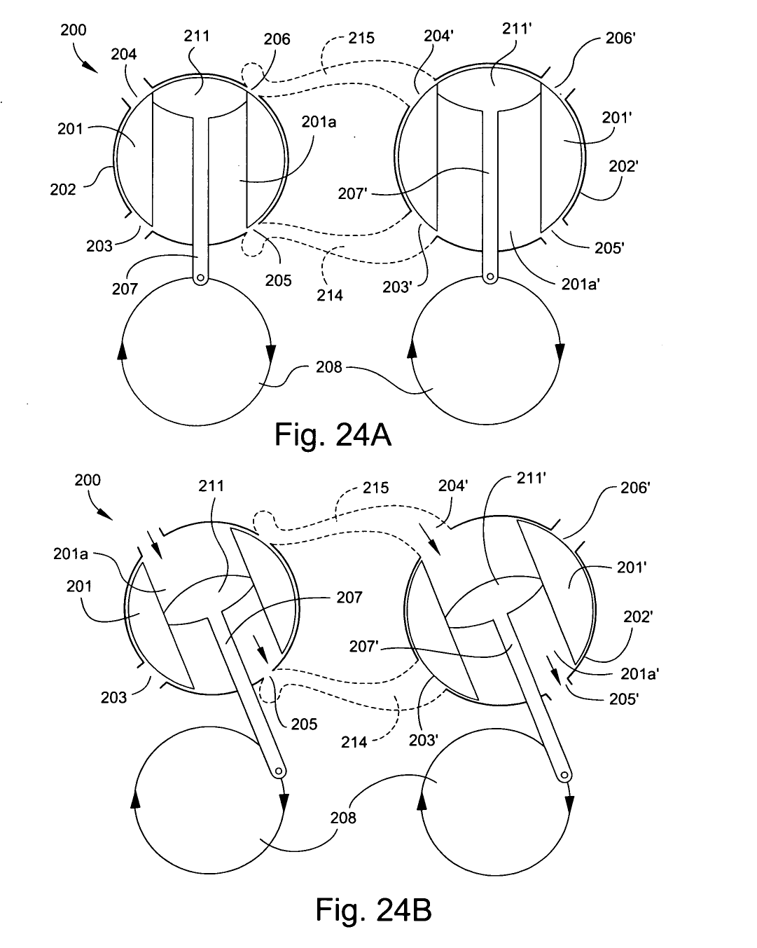

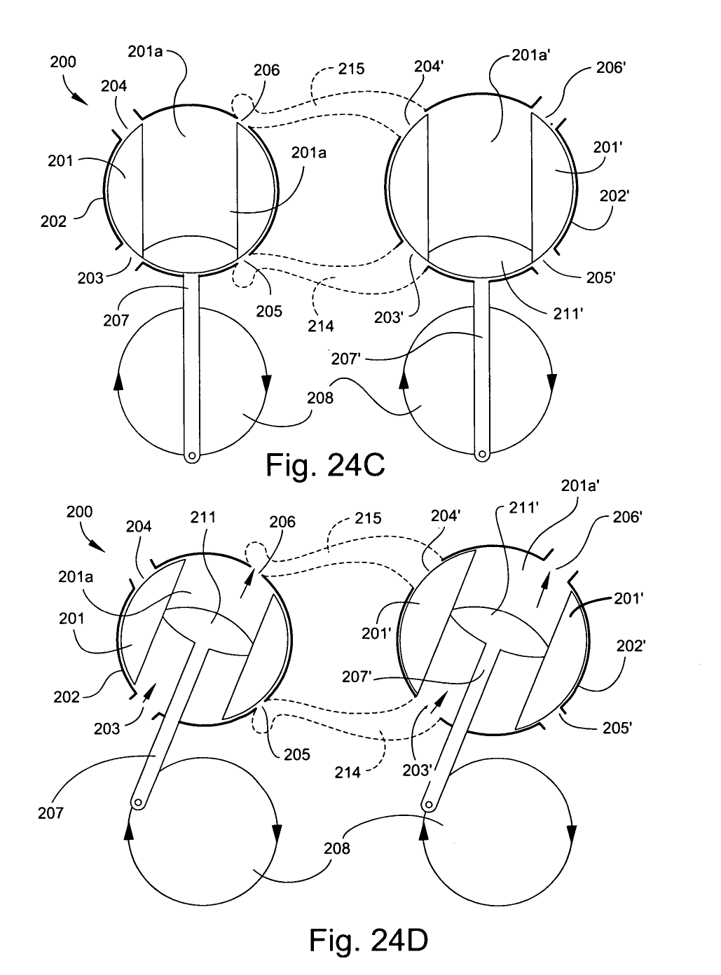

An alternative two sided embodiment is illustrated in FIGS. 24A-D and 25, and shown generally at reference numeral 200. The cylinders 201, 201′ define cylindrical chambers 201a, 201a″, respectively, and are positioned for reciprocal rotational movement within housing sections 202, 202′, respectively. Each housing section 202, 202′ includes a pair of entrance ports 203, 204, 203′, 204′, respectively, and a pair of exit ports 205, 206, 205′, 206′, respectively. Ignition chambers 214, 215 are mounted on the exit ports 205, 206, respectively, of the first housing section 202 and extend to the entrance ports 203′, 204′, respectively, of the second housing section 202′. The second cylinder 201′ is larger than the first cylinder 201 to achieve an expansion volume larger than the compression volume. The first cylinder 201 is used for intake and compression on both sides of the piston head 211. Since the crankshaft 208 must transfer power for compression from the second cylinder 201′, the size and strength of the piston rod 207 and crankshaft 208 must be larger than in the first two sided embodiment disclosed above. Except in applications where low weight and compactness is more important than efficiency, this arrangement 200 is the preferred embodiment.

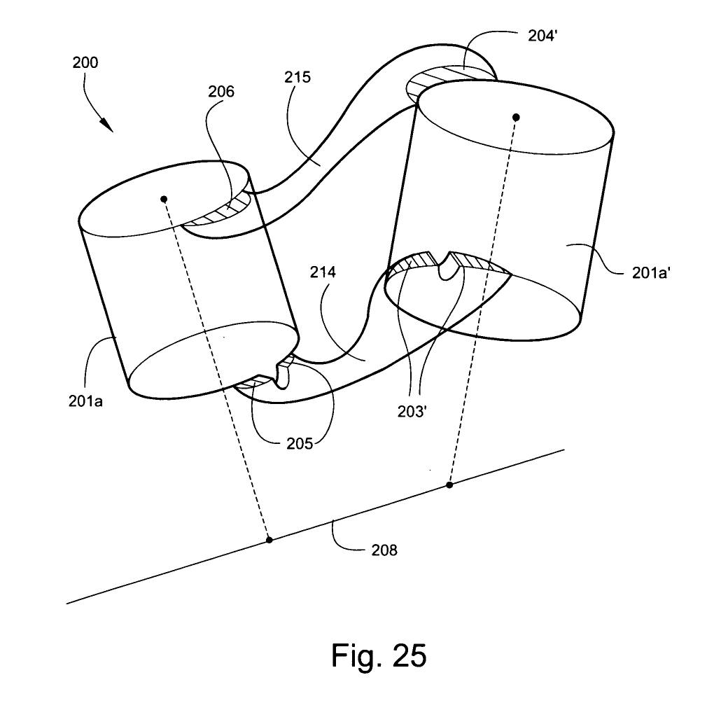

The engine 200 shown in FIGS. 24A-D and 25 is considerably more flexible than the engine 180 shown in FIGS. 20A-D. Not only can the cylinders 201, 201′ be of different size, but they can be offset, as shown in FIG. 25, to reduce the length of the ignition chambers 214, 215 for both ends of the cylinders 201, 201′. Furthermore, the crankshaft 208 can bring the first cylinder 201 to top dead center and bottom dead center somewhat before that of the second cylinder 201′. This is desirable in engines designed to run at higher rpm's.

Where fuel is introduced prior to intake, there is a limit to how much the first cylinder 201 can be advanced before the second cylinder 201′. With such an advance, the beginning of the compression stroke will push intake into the ignition chambers 214, 215 prior to the closing of the ignition chambers” openings to the second cylinder at the end of the power stroke. Too much advance will contaminate the second cylinder 201′ with unburned fuel prior to exhaust. This limit does not exist for compression ignition engines or where fuel is injected into the first cylinder 201 after the closing of the ignition chambers” openings to the second cylinder 201′.

Perhaps the most significant automotive engine advance of the 1 990's was the introduction of variable valve timing. While impressive power bandwidth gains were achieved, it was at the cost of introducing another layer of complexity into an already very complicated technology.

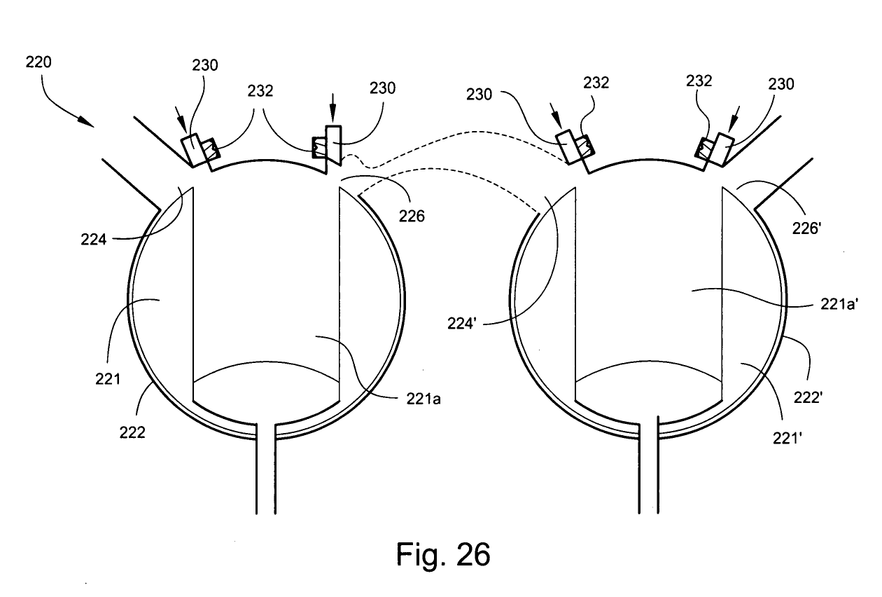

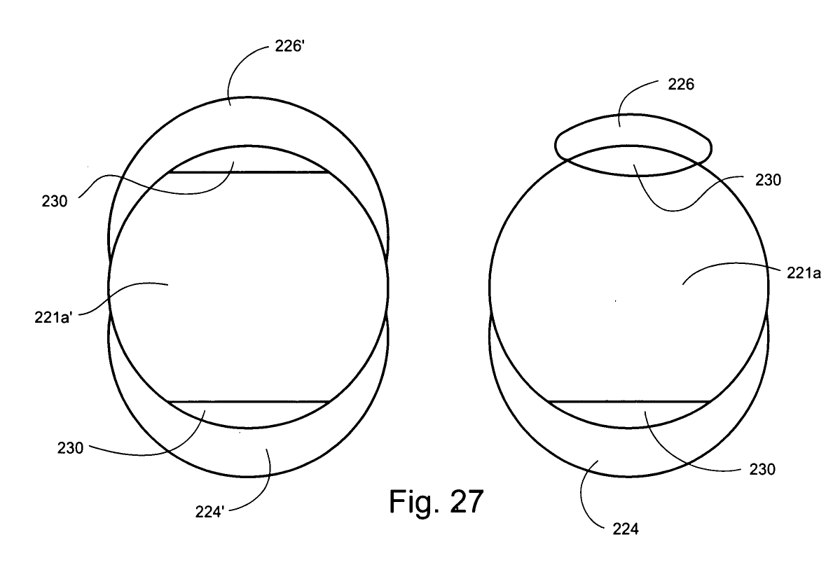

The embodiment 220 shown in FIGS. 26 and 27 offers a simple adaptation of the above-described engines which achieves variable timing of the ports 224, 226, 224′, 226′ of a pair of cylinders 221, 221′. The adaptation is shown for the one sided version only, but works the same way for the two sided version. The ports 224, 226, 224′, 226′ are enlarged and revealed earlier and shut off later by having part of the housing sections 222, 222′ of the oscillating cylinders 221, 221′ be movable next to the fixed ports 224, 226, 224′, 226′. The simplest embodiment of this is a timing piston arrangement 230 such as illustrated in FIGS. 26 and 27. FIG. 26 shows the timing pistons 230 in the full open position. These positions both enlarge the ports and lengthen the time the ports 224, 226, 224′, 226′ are open. The closed positions bring the porting back to that illustrated in previous paired cylinder embodiments, and is desirable for starting and at low rpm's.

The preferred embodiment of the mechanism to move the timing pistons 230 is assumed a worm gear 232. This type of gear makes the timing pistons 230 naturally resistant to being moved by pressure changes in the working volumes. The pistons 230 need only move when the timing is being changed to accommodate changed engine conditions. The different pistons 230 can be infinitely and separately variable.

FIG. 27 illustrates a possible profile of the timing pistons 230 and stationary ports 224, 226, 224′, 226′ as viewed from the top relative to the position of the cylinder barrels at top and bottom dead center. Actual development of particular engines is necessary to find the optimum size and shapes of any movable timing ports 230 for various applications. In some applications, multiple pistons of this type might be positioned next to individual ports. Timing pistons 230 for the ignition chamber affect the compression ratio. If needed, that could be defeated by a separate piston, or other mechanism controlling the volume of the ignition chamber. Defeating a lowered compression ratio may not be desirable. A lower ratio may be necessary to prevent preignition at higher rpm's, particularly where turbo or superchargers kick in at higher rpm's. The timing pistons 230 can be designed to give the appropriate reduction in compression for the higher rpm's.

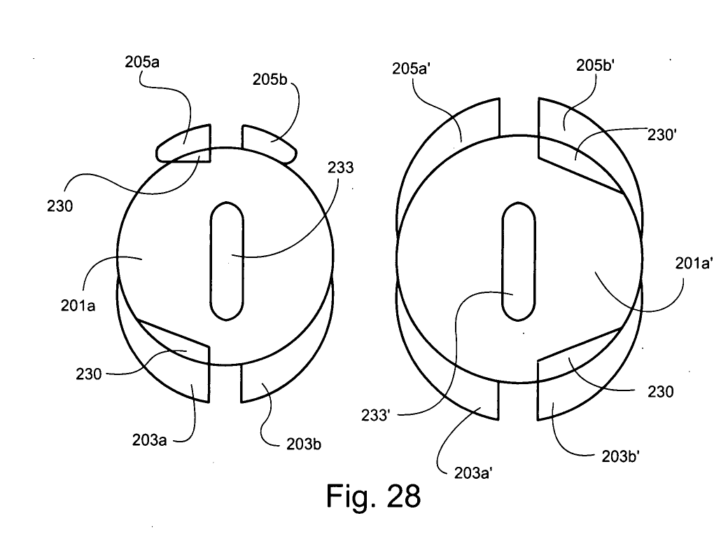

Introducing timing pistons on the crankshaft side in two-sided operation is more difficult because of the clearance needed for the piston rods. It is easier to add timing pistons only to the outside segmented ports 203a, 205a, 203b′, 205b′ for the two cylinders 201, 201′ of the engine 200, and not the port segments 203b, 205b, 203a′, 205a′ between the piston rod slots 233, 233′. This is illustrated in FIG. 28 for the more flexible embodiment of engine 200, where the second cylinder 201′ is larger than the first cylinder 201.

Although these timing pistons 230 are infinitely variable in the degree to which they are open or closed, they do not allow separate timing of opening and closing. For example, if the timing piston 230 in the fully open position begins revealing the entrance port 224 at 8 degrees before top dead center, the entrance port 224 will not be fully closed until greater than 8 degrees after bottom dead center. The exact point of closure depends on the distance to the crankshaft of the cylinder 221 and the rotational radius of the crankshaft, and is fixed for a given layout of the engine. The point of closure cannot be changed independently of the opening point. Prior art internal combustion engines usually have the intake valves open shortly before top dead center on the exhaust/intake transition while the exhaust valves close shortly after top dead center. The opening of the exhaust valves is usually significantly before bottom dead center on the power/exhaust transition. Similarly, intake valves can close significantly after bottom dead center on the intake/compression transition such as in “Miller” or “Atkinson” cycle engines. The valves must open and close near top dead center on the exhaust/intake transition to minimize the overlap where exhaust and intake valves are simultaneously open. The greater the overlap, the more the intake can contaminate the exhaust and cause unburned gases to escape with undesirable consequences for both efficiency and emissions. In the engines presented here, with intake and exhaust being done in separate cylinders, overlap between those two functions is generally not an issue. Thus, the apparent drawback of not having opening and closing times independently variable is not necessarily a serious one.

Low mass of the oscillating cylinders will help enable a higher rpm engine. A spherical cylinder with its pivot point sides largely removed, such as shown in FIG. 3D, provides a low inertial resistance to the oscillating motion. A housing with lubrication ports can embrace such an oscillating cylinder with little mechanical sloshing or frothing of the lubricant, which can also serve as a coolant. Various means can be utilized to achieve a low mass for an oscillating cylinder such as hollow or honeycombed castings and/or low mass materials. Aluminum and carbon-carbon composites, among other materials may be used with better wearing or less reactive coatings or sleeves. Alternatively, high mass materials can be removed where they are not needed for strength and replaced with lower mass materials without changing the sleek profile which minimizes lubricant agitation.

Maintaining the sleek outside profile of the cylinder, while reducing resistance to the oscillating motion, may not be the most efficient way to cool the cylinders. Eliminating material where it is not needed for proper sealing or strength would reduce inertial mass and aid in cooling. These gains may be more important than the loss from increased agitation of the lubricant/coolant. FIGS. 8A, 8B, 9A, and 9B illustrate some of the cylinder shapes that could serve these purposes. It should be noted that the cylinders would not have to be immersed by the lubricant/coolant from a chamber formed by inner and out housings. The lubricant/coolant could be delivered in a stream or spray. After draining down following such a delivery, the lubricant/coolant could be cooled again. This arrangement would minimize mechanical losses from the inertial resistance of the lubricant/coolant to back and forth sloshing.

One of the inefficiencies of existing art internal combustion engines results from the pumping losses from having intake flows throttled remotely prior to the intake manifold. The purpose of the throttle is to reduce the intake of air into the cylinders at idle or light load to prevent the air/fuel mixture from becoming too lean for combustion to be ignited. But having the throttle so remote from the cylinders means that, on intake, the pistons must move the whole column of gases in the manifold all the way back to the throttle. Several options to reduce the pumping losses from such a remote throttle have been explored in recent years.

One experimental option has been to develop a truly throttleless engine like a diesel, but still mix the fuel with air to achieve a homogeneous charge prior to ignition to minimize unburned hydrocarbons in the exhaust. To maintain the conditions within the cylinders such that ignition occurs spontaneously at the appropriate time is difficult. An alternative is to maintain conditions close to but still sufficiently below what would cause spontaneous ignition that it cannot occur and to induce ignition with a spark. A means to vary the compression ratio could enable such an approach.

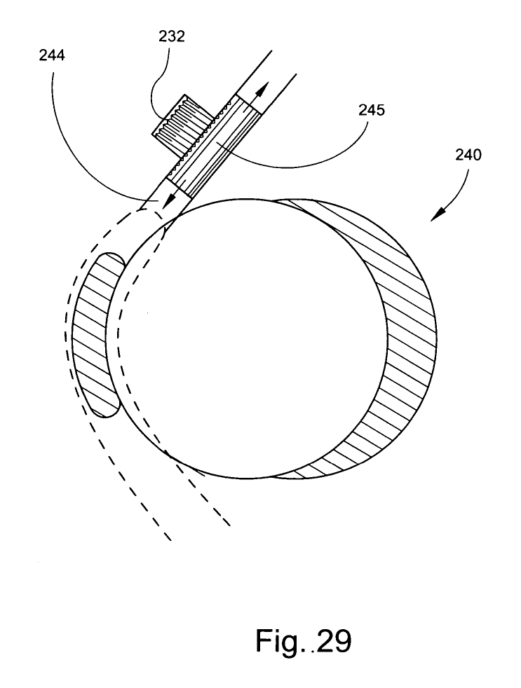

A piston at the beginning of a horn shaped ignition chamber could achieve this without altering the basic shape. FIG. 29 illustrates such a piston 245 positioned within ignition chamber 244 on cylinder assembly 240. Spark or any fuel injection into the ignition chamber 244 can be done anywhere near the beginning of the stationary part of the chamber 244. Alternatively, it can be done through the compression-varying piston 245 itself. Such a compression altering piston 245 could also be used to enable burning of different fuels, to accommodate the kicking in of a supercharger or as an aid in starting. Of course the ignition chamber would not have to have a horn shape to have a compression varying piston. A bulb shaped ignition chamber such as presented in FIGS. 20A-D and FIGS. 21A-C could similarly incorporate such pistons.

Another option now used in actual production vehicles is to bring the throttle right to cylinders by varying the lift of the intake and sometimes also the exhaust valves. Thus, a long column of air need not be pumped. Only the air actually brought into the cylinders needs to be pumped. The cost of such variable lift valves is the additional complexity added to an already too busy head. In the engines presented here, the same result can more easily be achieved by introducing a throttling mechanism at the intake entrance to first cylinder and perhaps also at the exhaust exit from the second cylinder. Any number of mechanisms including the traditional butterfly valve can be used. With no poppet valves in the way, the throttle valves can be positioned quite close to the cylinders. If the throttling were done by pistons similar to the timing pistons presented above, the throttle would be right at the entrance to the cylinders.

Throttling the entrance reduces the density of intake in the first cylinder and subsequently in the ignition chamber. Simultaneous operation of a compression-varying piston in that chamber could bring that density back to what is desirable for most efficient combustion. The net effect of these two operations would be basically equivalent to a light load reduction of compression volume relative to the expansion volume.

Another way to deal with throttle losses is to shut down some of the cylinders at idle or low load and to hold all the valves for the shut down cylinders open. In the already busy cylinder head of conventional engines, this would introduce an unwanted extra layer of complexity. However, in the present invention, it would be much easier. Cylinders can be shut down by opening up the cylinders either through the existing ports or by having separate coasting valves added at an appropriate place such as in the housing between the active ports. Since the crankshaft side has tighter clearances, a natural choice is to provide for the shutting down of the working chambers on the non-crankshaft side of the pistons.

In a hybrid vehicle, all the cylinders can be shut down under very light loads with a battery operated electric motor taking over. By so doing, the fuel consumed in idling is saved. Other types of hybrids are also possible including those mating stored compressed air and combustion engines. In general, the present invention would help enable all feasible hybrid types because of the weight, space and cost savings over the existing art.

Another possibility would be to mate engines of this invention with generators and those in turn with electrically driven motors as in a diesel electric locomotive. Such a mating would eliminate the need for transmissions in roadway vehicles. Capitalizing on the invention's potential use in very small engines, a small engine generator combination might be used to power accessories and for creeping in traffic jams and drive through lanes while larger engine generator combination(s) would kick in when needed for moving at speed.

Recently, carbon-carbon composites have been offered as a material enabling ring-less and oil-less piston engines. Their use is one solution to the issue of cylinder wall lubrication, assuming oxidation and cost barriers can be overcome. Without such composites, it must be assumed that some use of piston rings will generally be mandated in non-miniature applications. With the one sided versions, the lubrication of the cylinder walls need not be different from that of existing 4-stroke engines. The two-sided versions need special consideration, however. Some prior art piston rods have a passage bringing oil from the crankshaft up to the piston and out to the cylinder walls. This arrangement can also be used here with the passage bringing oil out to the cylinder walls between the rings for the two separate working chambers. Since the oil must not enter either of the working chambers and has no way to fall back into the crankcase, there must be a separate passage or passages returning the oil to the crankcase. Many piston rods have an H or dog-bone shaped cross section. With such a cross section, a passage can be incorporated into each of the two meaty ends—one up and one down. Of course, the piston rod hole in the alignment band would have to match. Another option would be to have a single passage bring trace amounts of oil out to the cylinder walls from between the rings. Alternatives in smaller or simpler engines would include bringing oil into the cylinder barrels via check valves, as presented above, or by adding lubricant to the fuel burned.

The cooling requirements of the cylinders of this invention might be somewhat less than in equivalent conventional engines, because of ignition occurring outside the cylinders. That would not likely be the case where the ignition chambers have ceramic coatings or linings. But in the cases where the expansion volume is made larger than the compression volume, exhaust temperatures are thereby reduced. The resulting improvement in thermal efficiency would have the side benefit of reducing the cooling load.

The housing can be cooled by any means, including a conventional water jacket and radiator system. Alternatives include having cooling fins on the housing, which can have voids filled with sodium or other high thermally conductive materials to conduct heat to the cooling fins. Housing materials which can withstand high temperatures could be explored, especially for use in compression ignition engines. A water jacket around the oscillating cylinders is not considered feasible. A more natural way to cool the cylinders is to cool the cylinder lubricant which is held in a chamber formed by inner and outer sections of the housing, or which is made to flow through hollow cavities in the cylinders. A lubricant chamber could be open to the cylinders through openings 57 such as illustrated in FIG. 10. A high thermally conductive lubricant would be preferred. Where cooling requirements are especially high, the cylinders themselves can have thermally conductive fillings to aid in heat transfer.

Where a chamber between inner and outer sections of the housing is filled with lubricant, it might be desirable to have the chamber drain down when the engine is not running, so as to limit leakage. The need for this would depend on the viscosity of the lubricant and the cold engine clearance between the cylinder and the inner housing. As noted above, the cylinder need not be immersed by a lubricant/coolant from such a chamber. In such a case, the draining down of a chamber between inner and outer housing sections would not be an issue.

For the smallest engines, a lubricant chamber within the housing probably would not be preferred for reasons of space and mechanical simplicity. The cylinder-housing interface might have mated ridges and grooves to increase the surface area across which heat can flow. A thermally conductive grease might be appropriate for that interface.

Alternatively, as noted above, the cylinder can have openings and voids bringing a cooling lubricant to the outside of the cylinder barrels but within the outside shell of the moving cylinder. With sufficient flow, that would eliminate the need for a high transfer of heat across the cylinder—housing interface. In this case, where the lubricant within the hollow cylinder cavities must move with the cylinder, a low density lubricant would be preferred to minimize the momentums that must be reversed.

So far the issues of vibration, and the dynamic balance of moving parts, have not been addressed. In general with the existing art, two cylinder in-line engine arrangements are not preferred because, with equal spacing of power strokes, the pistons must reciprocate in tandem. Although the resulting inducement to vibrate can be compensated for by balancer shafts, such means are usually not resorted to in engines that simple. Our basic engine module of paired cylinders, with pistons reciprocating in tandem, shares this drawback. On the other hand, the pistons of this invention need not be as massive as prior art pistons which are skirted and must embrace wrist pins. A vee relation between the cylinders and a staggering of the timing of the top dead center positions will also moderate the tendency to vibrate. Furthermore, in two sided operation, the piston momentum driven by the power stroke is moderated by compression within the cylinder or, where applicable, by having a large expansion volume. Where compression and intake are performed in a dedicated cylinder, energy lost to slowing piston momentum at the end of the strokes in that cylinder is presumably very small, or zero, for compression is at a peak at the point where momentum must be halted. The energy given up by the slowing piston to the compressed gases is not lost to the system, although it is lost to that cylinder and does not power the regain of piston momentum after the direction reversal, except indirectly via the crankshaft. In all the versions, proper sizing of exhaust ports can use the momentum that must be necessarily lost to the piston at the end of those strokes to drive the pumping of the remaining exhaust from the cylinder. With proper attention to such details, less of the momentum of the pistons at the end of the throws needs to be transferred to the crankshaft and thereby wasted in heat or undesired vibration.

Multi-cylinder engines using this invention could be laid out so that there is little inherent tendency to vibrate. For example, two cylinder pairs of this invention could be formed into a horizontally opposed or “boxer” engine. Other than the necessary offset on the crankshaft, the resulting engine would be perfectly balanced at the crank, both in terms of piston throws and in terms of momentum reversals of the oscillating cylinders. Where the power strokes occur in dedicated cylinders, keeping those cylinders as close together on the crankshaft as possible would minimize the effect of the necessary crankshaft offset. Another option having near perfect balance would be to have two cylinders pairs in a 90 degree vee relation with all the cylinders sharing a single possibly overbalanced crankpin. The overbalance would be to counteract not just the rotating masses but also the reciprocating piston rod and head masses, just as in prior art cross-plane V8 engines. As noted above, the necessary arresting of momentum at the end of stokes could be used to partially power compression or the completion of the exhaust strokes. In that case, overbalancing may not be mandated. The disadvantage of such a layout would be mostly the greater inertial mass of the crankshaft, if overbalanced. The advantages would be a more even spacing of firings (every 90 degrees instead of every 180 degrees of crank rotation in two sided operation) and a physical package more desirable in many applications. Alternative multi-cylinder engines could use other inherently balanced layouts or resort to using compensating balancer shafts.

A drive mechanism more efficient and reliable than a piston drive has not been developed for the low speeds appropriate to the most common engine applications. This invention shares the use of that drive and other qualities with the prior art. One drawback of typical piston drives is the power which is necessarily consumed simply reversing the direction of piston travel. This invention shares that drawback, albeit to a lesser extent in the two sided versions, and it introduces an additional element whose directional momentum must be continually reversed; the oscillating cylinder. Some options to keep the mass of the oscillating cylinder low, and to minimize the energy consumed in reversing its rotational momentum by use of pneumatic springs, have been introduced above.

Against any additional consumption of energy from reversing the momentum of the oscillating cylinders are a number of savings. Along with the mechanical simplicity of the oscillating cylinders comes the elimination of a number of reciprocating elements. Poppet valves, rocker arms, valve springs and the energy to operate them are eliminated, along with the non-reversing cams, chains or belts. Eliminating push rods, where applicable, provides a significant saving. Additionally, a skirtless piston head fused to the piston rod need not be as massive as a skirted one which must embrace a wrist pin. With the two sided versions of this invention, the number of working chambers and power strokes is doubled with no additional reciprocating masses while also providing additional means to reduce the energy costs of piston throw reversals. With proper attention to minimizing these masses and energy costs, this invention will waste less such energy than the prior art.

Theoretically, a prior art four stroke engine could be made to work on both sides of the piston just as in prior art steam engines. However, because of the needed crosshead, the linkage from piston to the crankshaft must be longer, thus adding reciprocating mass along with the space requirements. Furthermore, an additional set of valves with all the associated reciprocating parts must be added. The resulting engine would be very complicated, with only a marginal reduction of reciprocating masses. Presumably that is the reason such engines have not found favor.

Several variations of a four stroke oscillating cylinder internal combustion engine have been offered. All involve cylinder pairs which share a basic position on the crankshaft. The sharing of position on the crankshaft is key to keeping the passage(s) between the cylinders short. The oscillating cylinder assemblies of this invention could be paired in a four stroke engine with pistons 180 degrees apart on the crankshaft. In that case, the passages between the cylinders would necessarily be longer because the compression exits and the paired power entrances from the ignition chambers would have to be on opposite sides of the cylinder relative to the crankshaft. The advantage of such a pairing might be a slightly lighter crankshaft after balancing and possibly lower vibration from having the pistons reciprocate in opposite directions. The disadvantage, beyond the longer passages between the cylinders, would be mismatched working volumes on the two sides of the pistons. With the piston rods necessarily taking up part of the working volumes on the crankshaft side, the working volumes are smaller. One working volume pair must mate a compression from the crank side to an expansion volume on the opposite side. The other pair must have the reverse mating. The relation between compression volumes and expansion volumes cannot be the same for the different pairings. The relation between compression and expansion volumes for the two pairings must be, at best, a compromise. Engines using paired cylinders essentially out of phase are encompassed by this invention to the extent that they use the cylinder assemblies, or other features of the invention. Such assemblies would enable much shorter passages between mated pairs than the complicated assemblies of Thompson '578, referred to above.

One motivation for this invention is mechanical simplicity. Ignoring fuel delivery and ignition, only two independently moving parts per cylinder are needed to deliver power to the crankshaft. For the two sided versions, the reduction in moving parts is even more dramatic. For example, the equivalent of a four-cylinder conventional 4-stroke engine can be achieved in two cylinders with only four moving parts beyond the crankshaft. Where the two cylinders can be made as one piece, the number of such moving parts is only three. The mechanical simplicity allows space and cost savings to permit adoption of a variety of sophisticated control devices which would add to the efficiency of internal combustion engines. All of these controls involve parts which need only move when operating conditions change. The simpler crankshafts possible with this invention, which presumably can be made more resistant to twisting, can enable engines with more numerous cylinders and thereby smoother operation.

Additionally, this invention inherently facilitates a number of other efficiency and emissions gains. Since compression and power can be done in separate cylinders, different expansion and compression volumes are easily and naturally achieved. With intake and exhaust being done in separate chambers, it is easier to avoid fuel contamination of exhaust where fuel is mixed with air prior to intake. Where the two cylinders need not reach TDC at the same time, ignition can occur after compression is complete but before the power stroke begins. This will facilitate more complete combustion and enable more work to be obtained from the power stroke. By enabling two-sided operation, more compact 4-stroke engines are possible and the losses from reversing reciprocating masses, compressing valve springs and such can be reduced, along with permitting the number of pistons scraping cylinder walls to be halved. Finally, there is an increased mechanical advantage in having the piston attached directly to the crankshaft and a related reduction of piston-cylinder wall friction.

An embraced moving cylinder in a sealed housing and methods for using the same are disclosed above. Various details of the invention may be changed without departing from its scope. Furthermore, the foregoing description of the preferred embodiments of the invention and the best mode for practicing the invention are provided for the purpose of illustration only and not for the purpose of limitation; the invention being defined by the claims.

I claim:

1. A moving cylinder assembly comprising:
(a) a piston connected to a crank for reciprocal movement therewith;
(b) a cylinder defining a chamber for receiving and engaging the piston, the cylinder adapted for reciprocal oscillating movement with the piston; and
(c) a housing immediately embracing the cylinder and defining a slot through which the piston is positioned to allow for oscillating movement of the piston within the slot, whereby the immediate embracement of the cylinder by the housing minimizes leakage between the cylinder and the housing.

2. A cylinder assembly according to claim 1, wherein the cylinder assembly is adapted for use in an engine, compressor, pump or vacuum pump.

3. A cylinder assembly according to claim 1, wherein the cylinder is open on opposite ends for permitting the piston to approach the housing whereby dead space within the cylinder chamber is minimized.

4. A cylinder assembly according to claim 1, wherein externally provided pressure control of an interface between the cylinder and the housing minimizes leakage between the cylinder and the housing.

5. A cylinder assembly according to claim 1, wherein an interface between the cylinder and the housing is cylindrical.

6. A cylinder assembly according to claim 1, wherein an interface between the cylinder and the housing is spherical.

7. A cylinder assembly according to claim 1, wherein an end of the piston conforms to the contour of an inner surface of the housing.

8. A cylinder assembly according to claim 1, wherein the cylinder is mounted for rotational oscillation within the housing.

9. A cylinder assembly according to claim 1., wherein the cylinder is mounted for linear oscillation within the housing.

10. A cylinder assembly according to claim 1, wherein the cylinder and housing form at least one sealed cavity serving as a pneumatic spring aiding momentum reversals of the cylinder.

11. A cylinder assembly according to claim 1, wherein the housing defines at least one lubrication hole for allowing lubricant to flow into an interface between the cylinder and the housing.

12. A cylinder assembly according to claim 1, wherein the housing defines a first entrance port and a first exit port.

13. A cylinder assembly according to claim 12, further comprising means for varying the timing and the extent of the revealing of the cylinder chamber to the first entrance port and the first exit port.

14. A cylinder assembly according to claim 13, wherein the means for varying the timing and extent of the revealing of the cylinder chamber to the first entrance port and the first exit port comprises at least one timing piston operating in conjunction with a worm gear.

15. A cylinder assembly according to claim 12, wherein the cylinder defines at least a first aperture, and reciprocal movement of the piston yields oscillation of the cylinder whereby the first entrance port and first exit port are opened and closed to the cylinder chamber by intermittent alignment with the first aperture.

16. A cylinder assembly according to claim 12, wherein the first entrance port and the first exit port are crescent shaped.

17. An internal combustion engine comprising the moving cylinder assembly according to claim 15, further comprising compression means and an ignition chamber in communication with the first entrance port, and wherein the cylinder assembly extracts mechanical power from combustion and exhausts combustion byproducts with rotation of the crankshaft.

18. A cylinder assembly according to claim 12, wherein the piston comprises a piston head connected to a piston rod connected to the crank, and the cylinder further comprises an alignment band having a hole therein for receiving the piston rod therethrough, the alignment band for maintaining alignment of the cylinder with the piston rod, and whereby movement of the piston rod and piston head imparts oscillating movement to the cylinder.

19. A cylinder according to claim 18, wherein the alignment band is shaped and positioned for sealing the slot of the housing.

20. A cylinder assembly according to claim 18, wherein the piston head is shaped for complimentary engagement with the alignment band, whereby dead space within the cylinder chamber is minimized.

21. A cylinder assembly according to claim 18, wherein the housing defines a second entrance port and a second exit port positioned proximate the crank and the slot, and further wherein the first entrance port and the first exit port are positioned distally to the crank and the slot.

22. A cylinder assembly according to claim 21, wherein the second entrance port and second exit port each comprise first and second operative segments positioned on opposite sides of the alignment band.

23. A cylinder assembly according to claim 22, wherein the cylinder and the alignment band define second and third apertures, and reciprocal movement of the piston yields oscillation of the cylinder and the first and second operative segments of the second entrance port and second exit port are opened and closed by intermittent alignment with the second and third apertures.

24. An internal combustion engine comprising the cylinder assembly according to claim 21, and further comprising compression means and first and second ignition chambers in communication with the first and second entrance ports, and wherein the cylinder assembly extracts mechanical work from combustion and exhausts combustion byproducts with rotation of the crank.

25. An apparatus for use in a combustion engine comprising:
(a) first and second cylinder assemblies, each of the first and second cylinder assemblies comprising:
(i) a piston connected to a crank for reciprocal movement therewith,
(ii) a cylinder defining a chamber for receiving and engaging the piston, the cylinder adapted for reciprocal oscillating movement with the piston, and
(iii) a housing immediately embracing the cylinder, the housing defining a first entrance port, a first exit port, and a slot through which the piston is positioned to allow for oscillating movement of the piston within the slot, whereby the immediate embracement of the cylinder by the housing minimizes leakage between the cylinder and the housing;
(b) a passage communicating with the first exit port of the first cylinder assembly and the first entrance port of the second cylinder assembly whereby compressed gases exit the first cylinder assembly and enter the second cylinder assembly with combustion; and
(c) wherein the pistons of the first and second cylinder assemblies share a similar position on at least one crankshaft to minimize distance of the passage between the first and second cylinder assemblies.

26. An apparatus according to claim 25, wherein the first and second cylinder assemblies each define a second entrance port and a second exit port, and further comprising a second passage communicating with the second exit port of the second cylinder assembly and the second entrance port of the first cylinder assembly whereby compressed gases exit the second cylinder assembly and with combustion enter the first cylinder assembly, and further wherein a power stroke on one side of the piston of the first or second cylinder assembly drives a compression stroke on another side of the piston and intake strokes on one side of the piston in the first or second cylinder assembly are paired with exhaust strokes on the other side of the piston.

27. An apparatus according to claim 25, wherein the first and second cylinder assemblies each define a second entrance port and a second exit port, and further comprising a second passage communicating with the second exit port of the first cylinder assembly and the second entrance port of the second cylinder assembly, and whereby compressed gases exit the first cylinder assembly and with combustion enter the second cylinder assembly, and wherein intake and compression strokes occur on both sides of the piston in the first cylinder assembly and power and exhaust strokes occur on both sides of the piston in the second cylinder assembly.

28. An apparatus according to claim 25, wherein the passage communicating between the first and second cylinder assemblies is horn shaped.

29. An apparatus according to claim 25, wherein the first cylinder assembly and the second cylinder assembly are positioned in a vee arrangement.

30. An apparatus according to claim 25, wherein the second cylinder assembly is larger than the first cylinder assembly and whereby volume for the power stroke exceeds the volume for the compression stroke.

31. An apparatus according to claim 25, wherein the first cylinder assembly is brought to top dead center and bottom dead center ahead of the second cylinder assembly.
